(19) United States
(12) Patent Application Publication
(10) Pub. No.: US 2011/0060076 A1
(43) Pub. Date: Mar. 10, 2011

(54) EPOXY RESINS DERIVED FROM SEED OIL BASED ALKANOLAMIDES AND A PROCESS FOR PREPARING THE SAME

(76) Inventors: Robert E. Hefner, JR., Lake Jackson, TX (US); Jim D. Earls, Lake Jackson, TX (US); Jerry E. White, Lake Jackson, TX (US)

(21) Appl. No.: 12/988,819

(22) PCT Filed: May 18, 2009
(86) PCT No.: PCT/US09/44288

§ 371 Date: Oct. 21, 2010

Related U.S. Application Data
(60) Provisional application No. 61/055,240, filed on May 22, 2008.

(51) Int. Cl. C08L 63/00; C08G 59/00

(52) U.S. Cl. 523/400; 528/327; 525/523; 528/87; 525/524

(57) ABSTRACT

An epoxy resin comprising at least one epoxy amide such as at least one of a glycidyl ether amide and a glycidyl ester amide derived from at least one seed oil based alkanolamide; wherein the seed oil based alkanolamide is derived from the reaction of (i) at least one of a fatty acid ester, a fatty acid and a fatty acid triglyceride; and (ii) at least one alkanolamine; and a process for preparing such epoxy resin. An epoxy resin composition can be prepared comprising the epoxy amide above and one or more epoxy resins other than the epoxy amide. A curable epoxy resin composition can also be made from the above epoxy resin composition which contains at least one curing agent and/or at least one curing catalyst.

### FIELD OF THE INVENTION

The present invention relates generally to epoxy resins. More specifically, the present invention relates to epoxy resins such as glycidyl ether amides and glycidyl ester amides derived from alkanolamides, in particular, seed oil-based alkanolamides.

### BACKGROUND OF THE DISCLOSURE

Epoxy resins are one of the most widely used engineering resins, and are well-known for their use in composites with high strength fibers. Epoxy resins form a glassy network, exhibit excellent resistance to corrosion and solvents, good adhesion, reasonably high glass transition temperatures, and adequate electrical properties. Unfortunately, crosslinked, glassy epoxy resins with relatively high glass transition temperatures (>100° C.) are brittle. The poor impact strength of high glass transition temperature epoxy resins limits the usage of epoxies as structural materials and in composites.

Another major use for epoxy resins is in the preparation of coatings. While good adhesion, hardness and corrosion resistance can be achieved in said coatings, there is substantial room for improvement in the toughness and impact resistance, especially as glass transition temperature is increased. Furthermore, coatings prepared using aromatic epoxy resins suffer from chalking during exposure to sunlight. This severely limits the use of such coatings in outdoor applications.

Typical performance requirements of cured thermoset resins, including epoxy resins, include a high softening point (>200° C.), low flammability, hydrolytic resistance, chemical and solvent resistance, and a dielectric which is stable with changes in temperature. Epoxy resins may provide these properties, but various epoxy systems may include the drawback of slow hardening cycles due to slow kinetics.

Other drawbacks to various epoxy systems are the use of solvents, the resulting reaction by-products, and/or insufficient UV stability. Solvents and reaction by-products may result in unwanted chemical exposure or release and bubble formation during cure. Insufficient UV stability may also limit the end uses of epoxy systems completely preventing their use in most outdoor applications.

Accordingly, there exists a need for improvements in the processing of epoxy resins, such as by lowering viscosities and eliminating the need for solvents. There also exists a need to improve the performance of epoxy resin coatings, such as improvements in UV stability and flexibility and damage tolerance. Therefore, it is desired to provide improved epoxy resins useful for coatings.

Others, prior to the present inventors, have tried to provide improved epoxy resins useful for coatings from seed oil based materials. For example, vegetable oils which have been epoxidized through the double bonds in the backbone, and used in blends with the diglycidyl ether of bisphenol A is disclosed in Frischinger, P. Muturi, S Dirlikov, Two Phase Interpenetrating Epoxy Thermosets that Contain Epoxidized Triglyceride Oils Part II, Applications, Advances in Chemistry Series (1995), 239 (Interpenetrating Polymer Networks), 539-56.

H. Bjornberg, Novel Primary Epoxides, WO 00118751, Apr. 6, 2000, discloses that products obtained by esterifying an alcohol with an alkenoic acid may be epoxidized through the terminal double bonds and used in blends with the diglycidyl ether of bisphenol A.

Poly(glycidyl ethers), NL 660241 1, Aug. 8, 1966 discloses that poly(glycidyl ethers) of castor oil are prepared by reaction of castor oil with epihalohydrin in the presence of a Lewis acid catalyst with formation of polyhalohydrin esters of castor oil after which the latter are dehydrohalogenated to form epoxy resins.

J. L. Cecil, W. J. Kurnik, D. E. Babcock, Coating Compositions Containing Glycidyl Ethers of Fatty Esters, U.S. Pat. No. 4,786,666, Nov. 22, 1988, disclose high-solids coating compositions based on bisphenol diglycidyl ethers, castor oil polyglycidyl ethers, bisphenols, fatty acids and dimmer acids.

S. F. Thames, H. Yu, R. Subraminian, Cationic Ultraviolet Curable Coatings from Castor Oil, Journal of Applied Polymer Science (2000), 77(1), 8-13, disclose coatings formulated from castor oil glycidyl ether, epoxy resin UVR 6100, and photoinitiator UVI 6990.

None of the above prior art has met the long felt need of providing an epoxy resin based on seed oil alkanolamides with improved performance because: (1) the epoxy monomers cited in the prior art have higher epoxide equivalent weights due to their structure and higher oligomer content. This reduces crosslink densities and resultant thermo/mechanical properties of cured materials; and (2) most of the prior art is for epoxies with non-glycidyl ether structures due to the method of their preparation (oxidation of double bonds). Lacking the glycidyl ether structure dramatically reduces the reactivity of these epoxies with curing agents, such as diamines.

### SUMMARY OF THE INVENTION

One aspect of the present invention is directed to an epoxy resin comprising at least one epoxy amide derived from at least one alkanolamide.

In one embodiment, the alkanolamide preferably comprises at least one seed oil based alkanolamide such as at least one of a fatty acid ester, a fatty acid and a fatty acid triglyceride; and in this embodiment, the present invention is directed to an epoxy resin comprising at least one of a glycidyl ether amide or a glycidyl ester amide derived from at least one seed oil based alkanolamide such as at least one of a fatty acid ester, a fatty acid and a fatty acid triglyceride.

Another aspect of the present invention is directed to a process for preparing an epoxy resin comprising at least one epoxy amide, the process comprising reacting together: (a) at least one seed oil based alkanolamide such as at least one of a fatty acid ester, a fatty acid and a fatty acid triglyceride, (b) an epihalohydrin, and (c) a basic acting substance.

Still another aspect of the present invention is directed to an epoxy resin composition comprising the epoxy amide described above; and one or more epoxy resins other than the epoxy amide described above.

Yet another aspect of the present invention is directed to a curable epoxy resin composition comprising the epoxy resin composition described above; and at least one curing agent and/or at least one curing catalyst.

Other aspects and advantages will be apparent from the following description and the appended claims.

### DETAILED DESCRIPTION OF THE PREFERRED EMBODIMENTS

In one aspect, embodiments disclosed herein relate to improvements in the processing and performance of epoxy resin coatings. More specifically, embodiments disclosed herein relate to new glycidyl ether amides and glycidyl ester amides derived from fatty acid esters, fatty acids and fatty acid triglycerides. The glycidyl ether amides and glycidyl ester amides include monomers, oligomers and polymers thereof and mixtures thereof. The glycidyl ether amides and glycidyl ester amides of the present invention may be used in combination with other epoxy resins, and may result in advantages for example improved processing, UV stability, and flexibility/damage tolerance of the resulting epoxy resin coatings, composites, adhesives, electronics, and molded articles.

As noted above, the epoxy resins of the present invention are epoxy resins based on seed oil alkanolamides. For example, the epoxy resins of the present invention may include glycidyl ether amides and glycidyl ester amide derived from fatty acid esters, fatty acids and fatty acid triglycerides. The epoxy resins of the present invention may be represented by Formula I as follows:

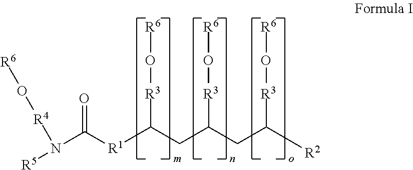

wherein R¹ and R⁴ may each independently be a hydrocarbylene moiety; R² is hydrogen or a monovalent hydrocarbyl moiety; R³ is nil or a hydrocarbylene moiety; R⁵ is hydrogen or a monovalent hydrocarbyl moiety, or a moiety represented by Formula II:

—R⁴—O—R⁶ Formula II

wherein R⁴ is as defined above; and R⁶ is a moiety of either Formula III or Formula IV as follows:

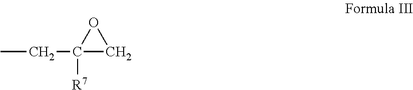

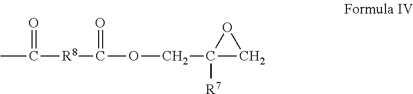

wherein R⁷ is hydrogen or an aliphatic hydrocarbon group having from 1 to about 4 carbon atoms; R⁸ is a hydrocarbylene moiety; and m, n, and o are independently 0 or 1, provided, however, that a sum of m, n and o is a positive integer greater than zero.

By “hydrocarbylene moiety” used herein it is meant a divalent moiety selected from the group consisting of an alkyl, a cycloalkyl, a polycycloalkyl, an alkenyl, a cycloalkenyl, a polycycloalkenyl, an aromatic ring substituted alkyl, an aromatic ring substituted cycloalkyl, an aromatic ring substituted polycycloalkyl, an aromatic ring substituted alkenyl, an aromatic ring substituted cycloalkenyl, and an aromatic ring substituted polycycloalkenyl moiety.

By “hydrocarbyl moiety” used herein it is meant a monovalent moiety selected from the group consisting of an alkyl, a cycloalkyl, a polycycloalkyl, alkenyl, cycloalkenyl, polycycloalkenyl, aromatic ring substituted alkyl, aromatic ring substituted cycloalkyl, aromatic ring substituted polycycloalkyl, aromatic ring substituted alkenyl, aromatic ring substituted cycloalkenyl, aromatic ring substituted polycycloalkenyl moiety.

An additional aspect of the present invention comprises the above glycidyl ether and ester amides in admixture with glycidyl ether and ester amides represented by Formula I wherein the sum of m, n and o is zero. These compositions preferably contain greater than or equal to about 70 percent by weight (wt %), and more preferably greater than about 90 wt %, in each case based upon total composition weight, of the glycidyl ether and ester amides having a sum of m, n and o greater than zero.

When R⁵ or R⁸ is a moiety containing an aromatic ring, said aromatic ring may contain one or more substituents including a halogen atom, preferably chlorine or bromine, a nitrile group, a nitro group, an alkyl or alkoxy group containing 1 to about 6, preferably 1 to about 4, and more preferably 1 to about 2 carbon atoms which may be substituted with one or more halogen atoms, preferably chlorine or bromine, or an alkenyl or alkenyloxy group containing 1 to about 6, preferably 1 to about 4, and more preferably 1 to about 3 carbon atoms. The aromatic ring may contain one or more heteroatoms such as N, O, S, and the like. Likewise, R⁴, R⁵ when it is a moiety other than H, and R⁸ may each independently contain one or more substituents including a halogen atom, preferably chlorine or bromine, an alkoxy group, an alkenyloxy group, an ether linkage (—O—), or a thioether linkage (—S—). The substituents may be attached to a terminal carbon atom or may be between two carbon atoms, depending on the chemical structures of the substituents. When R⁵ is an alkyl or alkenyl moiety, is may be linear (straight chained) or branched. The terms “cycloalkyl” and “cycloalkenyl” as used herein are also intended to encompass the corresponding di and polycyclo moieties.

In some embodiments, glycidyl ether and ester amide compositions disclosed herein may additionally include one or more of the following: monoglycidyl ethers or monoglycidyl esters derived from seed oil based alkanolamides; oligomers of the glycidyl ethers or glycidyl esters derived from seed oil alkanolamides; and combinations thereof.

In general, the epoxy resin of the present invention is prepared by a process (for example, an epoxidation reaction process) comprising reacting together the following components: (a) at least one alkanolamide such as a hydroxyl (OH) or acid (COOH) functionalized fatty amide intermediate; or mixtures thereof; (b) an epihalohydrin; and (c) a basic acting substance, preferably in a solid form. The process for preparing the epoxy resin of the present invention may also optionally comprise any one or more of the following components: (d) a solvent, (e) a catalyst, and/or (f) a dehydrating agent.

The epoxidation process for forming the epoxy resins of the present invention avoids any significant hydrolysis of the amide linkages that are present in the seed oil based alkanolamides. If hydrolysis is encountered in the operation of the process of the present invention, then optionally one or more dehydrating agents, component (f), may be employed in the process to prevent hydrolysis of amide linkages. The process of the present invention typically achieves epoxidation of at least about 80% or more of theoretical while maintaining the structural integrity of the amide linkages.

In one embodiment, the process for preparing the epoxy resins of the present invention involves an initial reaction of the OH or COOH functionalized fatty amide intermediate with the epihalohydrin to form a halohydrin intermediate. The halohydrin intermediate is then reacted with the basic acting substance to convert the halohydrin intermediate to the epoxy resin final product (the glycidyl ether and/or glycidyl ester).

In another embodiment, an alkali metal or alkaline earth metal hydroxide may be used as a catalyst; and if such catalyst is employed in stoichiometric or greater quantities, the initial reaction of the OH or COOH functionalized fatty amide intermediate and the epihalohydrin produces the halohydrin intermediate in situ. The halohydrin intermediate produced in situ may then be converted to the epoxy resin final product without the addition of the basic acting substance.

A preferred embodiment of the process further comprises first reacting the polyglycidyl ether derived from at least one of a fatty acid ester, a fatty acid and a fatty acid triglyceride with an alkali metal hydride to form an intermediate product, followed by reacting the intermediate product with the epihalohydrin; wherein the alkali metal hydride is preferably at least one of sodium hydride and potassium hydride. The basic acting substance may comprise at least one of an alkali metal hydroxide, carbonate, or bicarbonate; an alkaline earth metal hydroxide, carbonate, or bicarbonate; and any mixture thereof. The process is generally conducted at a temperature from about 20° C. to about 120° C.; and at a pressure from about 30 mm Hg to about 100 psia.

The seed oil based alkanolamides, component (a), useful in the present invention may be purchased from commercially available products on the market. For example, a commercially available seed oil based alkanolamide includes a lauric acid diethanolamide, commercial grade product sold by Rhodia, Inc. under the product name Alkamide LE®.

In another embodiment, the seed oil based alkanolamides useful in the present invention may be derived by the aminol ysis of saturated and unsaturated fatty acid esters; saturated and unsaturated fatty acids; or saturated and unsaturated fatty acid triglycerides; or mixtures thereof, i.e., the reaction of (i) at least one of the saturated fatty acid esters, unsaturated fatty acid esters, saturated fatty acids, unsaturated fatty acids, saturated fatty acid triglycerides, or unsaturated fatty acid triglycerides with (ii) an alkanolamine.

The unsaturated fatty acid esters or fatty acid triglycerides, component (i), suitable for aminolysis with a hydroxyl-functionalized amine include castor oil, soy bean oil, canola oil, rapeseed oil and methyl ricinoleate; and mixtures thereof.

Suitable saturated fatty acid esters and fatty acid triglycerides include methyl stearate; 12-hydroxymethylstearate; hydrogenated methyl ricinoleate and hydrogenated castor oil; and reductively hydroformylated fatty acid esters such as 9-methylhydroxymethylstearate, 10-methylhydroxymethylstearate, 9,12-methylhydroxymethylstearate, 9,12,15-methylhydroxymethylstearate, 11-hydroxymethylundecanoate, 10-hydroxymethyldecanoate; and mixtures thereof.

Some of the unsaturated fatty acids encountered in vegetable oils which are useful in the present invention are ricinoleic acid, oleic acid, linoleic acid, and linolenic acid; and mixtures thereof. Non limiting examples of fatty acids containing at least one ethylenically unsaturated bond that can be cited are myristoleic acid, palmitoleic acid, petroselenic acid, doeglic acid, erucic acid, isanic acid, stearodonic acid, arachidonic acid, and chypanodonic acid; and mixtures thereof.

Examples of saturated fatty acids that can be used in embodiments disclosed herein may include palmitic acid, lauric acid, capric acid, decanoic acid, stearic acid, isostearic acid, gadoleic acid and myristic acid; and mixtures thereof.

The amide polyols derived from biobased oils described in WO 2007/027223 A2, incorporated herein by reference, may also be used in the present invention.

The COOH functionalized saturated fatty acid esters, fatty acids and fatty acid triglycerides may be formed, for example, by reacting the aminol ysis products with carboxylic acid anhydrides such as maleic anhydride, succinic anhydride, phthalic anhydride, tetrahydrophthalic anhydride; mixtures thereof; and the like.

Fatty acid esters and fatty acids useful in embodiments disclosed herein may include those having a carbon number ranging from eight to twenty-two. Dimers and trimers of these fatty acid esters and fatty acids are also useful. The fatty acid ester and fatty acids are preferably derived from plant oils and if unsaturation exists, they can be modified by reductive hydroformylation. In a preferred embodiment, the fatty acid ester is a vegetable oil. Some of the fatty acids which can be obtained from vegetable oils and are useful in the present invention are ricinoleic acid, oleic acid, linoleic acid, stearic acid, lauric acid, myristic acid and palmitic acid.

Examples of oils of plant origin (fatty acid triglycerides) that can be used in embodiments disclosed herein may include rapeseed oil, sunflower oil, peanut oil, olive oil, walnut oil, corn oil, soya bean oil, linseed oil, hempseed oil, grapeseed oil, coprah oil, palm oil, cottonseed oil, babassu oil, jojoba oil, sesame seed oil, castor oil and coriander oil.

In one embodiment, the vegetable oil is castor oil which contains secondary hydroxyl groups and does not require reductive hydroformylation. Castor oil typically contains at least about 80 percent ricinoleic acid with about 89 percent being typical. Other fatty acid esters with a carbon number of 18 are also preferred. The balance of the castor oil may include other compositions.

Examples of oils of animal origin that can be used in embodiments disclosed herein may include sperm whale oil, dolphin oil, whale oil, seal oil, sardine oil, herring oil, shark oil, cod liver, calfsfoot oil and beef, pork, horse and sheep fats (suet).

The OH functionalized saturated fatty acid esters, fatty acids and fatty acid triglycerides may be formed, for example, by the aminol ysis of saturated fatty acid esters, fatty acids or fatty acid triglycerides.

Aminolysis may include reaction of saturated fatty acid esters, fatty acids or fatty acid triglycerides with alkanolamines. The alkanolamines, component (ii), may include, for example, amino monols, diols and triols, such as diethanolamine, 2-amino-2-methyl-1,3-propanediol, 2-amino-2-hydroxymethyl 1,3-propanediol, 2-amino-2-methyl ethanol; mixtures thereof; and the like.

Examples of epihalohydrin, component (b), used to prepare the epoxy resins of the present invention disclosed herein include, for example, epichlorohydrin, epibromohydrin, epiiodohydrin, methylepichlorohydrin, methylepibromohydrin, methylepiiodohydrin, and any combination thereof. Epichlorohydrin is the preferred epihalohydrin used in some embodiments of the present invention disclosed herein.

The ratio of the epihalohydrin to the functionalized saturated fatty acid ester or fatty acid triglyceride is generally from about 1:1 to 25:1, preferably from about 1.8:1 to about 10:1, and more preferably from about 2:1 to about 5:1 equivalents of epihalohydrin per primary or secondary hydroxyl group (preferably the primary hydroxyl group) in the functionalized saturated fatty acid ester, fatty acid or fatty acid triglyceride.

The term “primary hydroxyl group” used herein refers to the primary hydroxyl group or primary hydroxyl groups derived from the functionalized fatty amide intermediate. The primary hydroxyl group differs from the secondary hydroxyl group such as those formed during the process of the formation of the halohydrin intermediate. While the primary hydroxyl group is preferred, in some cases, the hydroxyl group present in the seed oil alkanolamides useful in the present invention may be secondary hydroxyl groups, for example the secondary hydroxyl group present in castor oil.

A basic acting substance, component (c), may be used in the present invention to react with the aforementioned halohydrin intermediate to form the final epoxy resin product of the present invention disclosed herein. Examples of the suitable basic acting substance include alkali metal hydroxides, alkaline earth metal hydroxides, carbonates, bicarbonates, and any mixture thereof or the like.

More specific examples of the basic acting substance include sodium hydroxide, potassium hydroxide, lithium hydroxide, calcium hydroxide, barium hydroxide, magnesium hydroxide, manganese hydroxide, sodium carbonate, potassium carbonate, lithium carbonate, calcium carbonate, barium carbonate, magnesium carbonate, manganese carbonate, sodium bicarbonate, potassium bicarbonate, magnesium bicarbonate, lithium bicarbonate, calcium bicarbonate, barium bicarbonate, manganese bicarbonate, and any combination thereof or the like. Sodium hydroxide and/or potassium hydroxide are the preferred basic acting substance.

The process of the present invention disclosed herein may be conducted in the absence of a solvent or in the presence of a solvent. If the solvent is absent in the process, the epihalohydrin may function both as a solvent and a reactant in such process. If the solvent is present in the process, the solvent used should be inert to the process of preparing the epoxy resins disclosed herein, including inert to the reactants, the catalysts, any intermediate products formed during the process, and the final products.

Examples of solvents which may be used in the present invention include aliphatic and aromatic hydrocarbons, halogenated aliphatic hydrocarbons, aliphatic ethers, aliphatic nitriles, cyclic ethers, ketones, amides, sulfoxides, and any combination thereof or the like. Other solvents which may be used include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, N,N-dimethylacetamide, acetonitrile; any combination thereof; or the like.

If a solvent is used in the process of the present invention, a minimum amount of solvent needed to achieve the desired result is preferred. In general, a solvent may be present in the process from about 250 percent to about 1 percent by weight, preferably from about 50 percent to about 1 percent by weight, and more preferably from about 20 percent to about 5 percent by weight based on the total weight of the functionalized saturated fatty acid ester or fatty acid triglyceride. The solvent may be removed at the completion of the reaction of forming the epoxy resins described herein using conventional methods, such as vacuum distillation.

A catalyst may also, optionally, be used to prepare the epoxy resins of the present invention described herein. Examples of the catalyst include quaternary ammonium or phosphonium halide. More specific examples of the catalyst include benzyltrimethylammonium chloride, benzyltrimethylammonium bromide, tetrabutylammonium chloride, tetrabutylammonium bromide, tetraoctylammonium chloride, tetraoctylammonium bromide, tetrabutylammonium bromide, tetramethylammonium chloride, tetramethylammonium bromide, tetrabutylphosphonium chloride, tetrabutylphosphonium bromide, tetrabutylphosphonium iodide, ethyltriphenylphosphonium chloride, ethyltriphenylphosphonium bromide, ethyltriphenylphosphonium iodide; any combination thereof; or the like.

While the amount of catalyst may vary due to factors such as reaction time and reaction temperature, the lowest amount of catalyst required to produce the desired effect is preferred. In general, the catalyst may be used in an amount of from about 0.01 percent to about 3 percent by weight, preferably, from about 0.05 percent to about 2.5 percent by weight, and more preferably, from about 0.1 percent to about 1 percent by weight based on the total weight of the functionalized saturated fatty acid ester or fatty acid triglyceride.

In preparing the epoxy resins of the present invention, other components may be present or purposely added in minor amounts to the OH and COOH functionalized fatty amide intermediate. Examples of minor components which may be purposely added to the OH and COOH functionalized fatty amide intermediate include aliphatic diols or polyols and cycloaliphatic diols other than the OH and COOH functionalized fatty amide intermediate.

More specific examples of the minor components include ethylene glycol, diethylene glycol, poly(ethylene glycol)s, trimethylolpropanes, cyclohexane diols, norbornane dimethanols, and dicyclopentadiene dimethanols, and any combination thereof or the like. The diols or polyols may be epoxidized simultaneously during the epoxidation of the OH and COOH functionalized fatty amide intermediate. The resultant epoxy resin comprises a mixture of the epoxy resin produced from the OH and COOH functionalized fatty amide intermediate and the epoxy resin produced from the respective aliphatic diols, aliphatic polyol, or cycloaliphatic diol other than the functionalized fatty amide intermediate. In this manner, a specific mixture of epoxy resins may be obtained without mixing of epoxy resins from separate sources. This may be done to obtain specific properties, such as, for example, a reduction in viscosity relative to the viscosity of the epoxy resin of the functionalized fatty amide intermediate.

The amounts and types of the minor components may vary depending on the specific chemistry of the components and the process used to prepare the OH and COOH functionalized fatty amide intermediate. In general, the minor components may comprise less than about 25 percent, preferably from about 0.001 percent to about 10 percent, and more preferably from about 0.001 percent to 1 percent minor components based on the total weight of the functionalized fatty amide intermediate.

The process for preparing the epoxy resins of the present invention may be carried out under various conditions. For example, the temperature for the process for preparing the epoxy resins described herein is generally from about 20° C. to about 120° C., preferably from about 30° C. to about 85° C., and more preferably from about 40° C. to about 75° C.

The pressure for the process for preparing the epoxy resins described herein is generally from about 30 mm Hg to about 100 psia, preferably from about 30 mm Hg to about 50 psia, and more preferably from about 60 mm Hg to about atmospheric pressure (for example, 760 mm Hg).

The time for completion of the process for preparing the epoxy resins described herein is generally from about 1 to about 120 hours, more preferably from about 3 to about 72 hours, and more preferably from about 4 to about 48 hours.

Various analytical methods (for example, gas chromatography (GC), high performance liquid chromatography (HPLC), and gel permeation chromatographic (GPC)) may be used to determine the completion of the process. The exact analytical method selected depends on the structure of the reactants and the epoxy resin products. For example, HPLC analysis may be employed to monitor reaction of the OH and COOH functionalized fatty amide intermediate concurrently with the formation of intermediate products and final products (for example, the diglycidyl ethers of the saturated fatty acid ester, the mono and diglycidyl ethers of functionalized saturated fatty acid ester, and any oligomer thereof). GPC analysis may also be employed to analyze the oligomers which are not volatile and are generally not detected by analytical methods such as gas chromatography.

Other analytical methods, such as infrared spectrophotometric (IR) analysis and nuclear magnetic resonance (NMR) spectroscopy, are beneficially used to analyze the epoxy resin of the non-seed oil based alkanolamide. For example, IR analysis can be performed to readily verify retention of the amide structure in the epoxy resin product.

In addition, by using analytical methods to monitor the epoxidation process, the epoxy resins described herein with various components may be obtained. For example, a shorter reaction time and/or a lower reaction temperature generally leads to the formation of epoxy resins comprising a greater amount of the monoglycidyl ethers (esters) (or diglycidyl ethers or esters) of OH or COOH functionalized fatty amide intermediate accompanied by a lesser amount of the oligomers of such epoxy resins. Conversely, a longer reaction time and/or a higher reaction temperature generally leads to the formation of epoxy resins comprising a lesser amount of the monoglycidyl ethers (esters) (or diglycidyl ethers or esters of OH or COOH functionalized fatty amide intermediate accompanied by a greater amount of the oligomers of such epoxy resins. Accordingly, the combination of reaction time and reaction temperature may be adjusted to provide the desired epoxy resins.

According to various embodiments, the epoxy resins of the present invention described herein may be prepared by various epoxidation processes including for example (1) a slurry epoxidation process, (2) an anhydrous epoxidation process, or (3) a combination of a Lewis acid catalyzed coupling reaction and a slurry epoxidation reaction process.

The slurry epoxidation process useful in the present invention comprises reacting together the following components: (a) a OH or COOH functionalized fatty amide intermediate such as any of the aforementioned functionalized fatty amide intermediate; (b) an epihalohydrin such as any of the aforementioned epihalohydrins, and (c) a basic acting substance, such as any of the aforementioned basic acting substances, in a solid form or in an aqueous solution.

The slurry epoxidation, process (1), may optionally comprise any one or more of the following components: (d) a solvent or a mixture of solvents other than water, (e) a catalyst, and/or (f) a dehydrating agent. If hydrolysis is encountered in the operation of the slurry epoxidation process of the present invention, then one or more dehydrating agents (f) may be employed in the process to prevent hydrolysis of amide linkages.

In the slurry epoxidation process, when the basic acting substance is in a solid form, it is usually in the form of a pellet, a bead, or a powder. Various particle sizes or particle size distributions of the basic acting substance may be used. For example, the basic acting substance, such as solid sodium hydroxide, having a particle size distribution of from about −40 to about +60 mesh, or from about −60 to about +80 mesh may be used. In another embodiment, the particle size distribution used may be about −80 mesh.

In the slurry epoxidation process, when the basic acting substance is obtained as an aqueous solution, the aqueous solution is first added to the solvent or a mixture of solvents other than water to form a solvent-water azeotrope or a co-distillable mixture with the solvent or the mixture of solvents and water. The water in this aqueous solution of the basic acting substance can be removed via an azeotropic distillation of the solvent-water azeotrope or co-distillation of water with the solvent or a mixture of solvents. This distillation is usually done under vacuum. The distillation may be performed continuously until the desired basic acting substance is produced either as a neat solid (dry) or as a solvent slurry (with residual non-aqueous solvent). If residual solvent is left behind to form a solvent slurry of the basic acting substance, the solvent used should be inert to the slurry epoxidation reaction including the reactants, any intermediate products, and the final products. Examples of such solvents include toluene and xylene.

In one embodiment, the slurry epoxidation process may further comprise (i) adding a solvent other than water to the basic acting substance in the aqueous solution, and (ii) removing the aqueous solution (water) from the basic acting substance via a vacuum distillation of a solvent-water azeotrope until the basic acting substance becomes a neat solid or a solvent slurry; wherein the solvent comprises toluene or xylene.

The term “azeotrope” refers herein to a mixture of liquids (for example, mixture of solvent and water in the slurry epoxidation process) that has a constant boiling point because the vapor form of the mixture has the same composition as the liquid form of the mixture. The components of the mixture usually cannot be separated by simple distillation.

The term “codistillate” refers herein to a mixture of liquids wherein water codistills with solvent. It is also possible to simply flash distill water from the aqueous solution of the basic acting substance to leave the dry basic acting substance behind as a solid.

Azeotropic distillation is a process for separating, by distillation, a product which is not easily separable otherwise. The essential characteristic of the azeotropic distillation process is an introduction of another component which forms an azeotropic mixture with an initial component in the product and the initial component is then distilled off leaving to obtain a pure product.

A dehydrating agent may also be used in the slurry epoxidation process to moderate or accelerate the slurry epoxidation reaction. The dehydrating agent may be added before, after or concurrent with the basic acting substance. The addition and use of said dehydrating agent is crucial with certain alkanolamide reactants to prevent hydrolysis of amide linkages.

Examples of the dehydrating agent include alkali metal sulfates, alkaline earth metal sulfates, molecular sieves, and any combination thereof or the like. More specific examples of the dehydrating agent include sodium sulfate, potassium sulfate, lithium sulfate, calcium sulfate, barium sulfate, magnesium sulfate, manganese sulfate, molecular sieves; any combination thereof; or the like.

In one embodiment of the slurry epoxidation process, the slurry epoxidation process involves adding the OH or COOH functionalized fatty amide intermediate to a stirred slurry of sodium hydroxide in epichlorohydrin. The sodium hydroxide may be in the form of a solid such as pellets, beads or powder or a mixture thereof. The solid sodium hydroxide may also be essentially anhydrous to slightly damp. The term “essentially anhydrous” or “slightly damp” as used herein means that the solid sodium hydroxide comprises less than about 5 percent by weight of water based on the total weight of the solid sodium hydroxide.

In general, the solid sodium hydroxide comprises less than about 5 percent, preferably less than about 4 percent, and more preferably less than about 2.5 percent by weight of water based on the total weight of the solid sodium hydroxide.

In another embodiment of the slurry epoxidation process, the slurry epoxidation process involves adding the OH or COOH functionalized fatty amide intermediate to a stirred slurry of sodium hydroxide and anhydrous sodium sulfate in epichlorohydrin. Both the sodium hydroxide and sodium sulfate may be in the form of a solid such as pellets, beads, powder, or granular. The solid sodium hydroxide may also be essentially anhydrous or to slightly damp, comprising less than about 5 percent by weight of water based on the total weight of the solid sodium hydroxide. The anhydrous sodium sulfate is preferred to be in the granular form.

According to the present invention, it is desired to produce the epoxy resin comprising the highest possible amount of the polyglycidyl ethers and polyglycidyl esters of the saturated fatty acid esters, fatty acids and fatty acid triglycerides concurrent with retention of the amide structure in said epoxy resin. However, it has been discovered that, during the slurry epoxidation process, as the reaction reaches about 95 weight percent or higher conversion of the OH or COOH functionalized fatty amide intermediate to the epoxy resin product, the viscosity of the reaction slurry increases, causing significant reduction in mixing and effective heat transfer from the reaction slurry. The increased viscosity makes it difficult to continue the reaction. Furthermore, under these conditions, a substantial amount of resulting monoglycidyl ethers (and diglycidyl ethers) may still be present. In order to reduce viscosity, concomitantly restore heat transfer, and thus continue the reaction, a further addition (also referred as “back-addition”) of epichlorohydrin may be needed. Generally, the epichlorohydrin may be back-added in an additional amount of from about 0.25 to about 1 equivalents of epichlorohydrin per primary hydroxyl originally present in the functionalized saturated fatty acid ester.

In the slurry epoxidation process, it is within the scope of the embodiments of the present invention disclosed herein to add a greater amount of epichlorohydrin at the inception of the reaction for eventual viscosity control. Generally, an additional amount of from about 0.50 to about 2 equivalents of epichlorohydrin per primary hydroxyl originally present in the OH or COOH functionalized fatty amide intermediate may be added at the inception of the reaction. However, it has been discovered that during the slurry epoxidation process, increasing epichlorohydrin stoichiometry above about 2 to about 3 equivalents of epichlorohydrin per primary hydroxyl in the mixture at the inception of the reaction may lead to additional formation of unwanted side-products. The formation of these unwanted side-products may consume valuable epihalohydrin as well as the basic acting substance, such as sodium hydroxide. The side-products, if produced, may be removed by vacuum distillation.

The epoxy resins of the present invention may also be prepared by an anhydrous epoxidation, process (2). The anhydrous epoxidation process comprises reacting together the following components: (a) a OH or COOH functionalized fatty amide intermediate such as any of those described above; (b) an epihalohydrin such as any of those described above; and (c) a basic acting substance in an aqueous solution such as any of those described above. The anhydrous epoxidation process may optionally comprise any one or more of the following components: (d) a solvent, and/or (e) a catalyst.

In the anhydrous epoxidation process, a basic acting substance in an aqueous solution may be used. The water in the aqueous solution of the basic acting substance and the epihalohydrin (for example, epichlorohydrin) form a binary epihalohydrin-water azeotrope or a ternary epihalohydrin-water-solvent azeotrope. The water may be removed via an azeotropic distillation or co-distillation of the epichlorohydrin-water azeotrope or the epihalohydrin-water-solvent azeotrope. The distillation may be performed under vacuum.

In a preferred embodiment of the anhydrous epoxidation process, the process may further comprise removing the aqueous solution (water) from the basic acting substance via a vacuum distillation of an epichlorohydrin-water azeotrope until the basic acting substance becomes a substantially anhydrous solid.

Details concerning the process of the removal of water during epoxidation via azeotropic distillation or co-distillation are given in U.S. Pat. No. 4,499,255, which is incorporated herein by reference.

In one embodiment of the anhydrous epoxidation process, the anhydrous epoxidation process involves controlled addition of the sodium hydroxide in an aqueous solution to a stirred mixture of a OH or COOH functionalized fatty amide intermediate and epichlorohydrin with continuous vacuum distillation of an epichlorohydrin-water azeotrope, removal of the water fraction from the distilled azeotrope, and recycle of the recovered epichlorohydrin back into the reaction. An aqueous solution comprising about 50 percent by weight of sodium hydroxide is particularly preferred. More dilute aqueous sodium hydroxide, while operable, is less preferred due to the additional time and energy expended to remove the additional water. A catalyst may also be added to the stirred mixture. A quaternary ammonium halide catalyst is particularly preferred.

If hydrolysis of amide linkages is encountered in the operation of the anhydrous epoxidation process, then one of the other epoxidation processes of the present invention is employed to prevent hydrolysis of said amide linkages.

The epoxy resins of the present invention may also be prepared by a Lewis acid catalyzed coupling reaction and slurry epoxidation reaction process (herein the “Lewis acid coupling/epoxidation process”), process (3). Generally, the Lewis acid coupling/epoxidation process comprises a catalyzed coupling reaction step followed by a slurry epoxidation reaction step. Accordingly, the Lewis acid coupling/epoxidation process comprises first reacting, in a coupling reaction step, (a) a OH or COOH functionalized fatty amide intermediate such as any of those described above, with (b) an epihalohydrin, such as any of those described above, in the presence of (c) a Lewis acid catalyst such as any of the catalysts described above. The coupling reaction step produces an intermediate product comprising a halohydrin. The intermediate halohydrin product is then reacted, in a dehydrohalogenation reaction step for example using an epoxidation process such as the slurry epoxidation process described above; with (d) a basic acting substance in a solid form. The Lewis acid coupling/epoxidation process may also optionally comprise any one or more of the following components: (e) a solvent, (f) a catalyst other than the Lewis acid catalyst, and/or (g) a dehydrating agent.

In a preferred embodiment of the a Lewis acid catalyzed coupling and epoxidation process, the coupling reaction of the process may comprise reacting the glycidyl ether derived from at least one of a fatty acid ester, a fatty acid and a fatty acid triglyceride with the epihalohydrin in the presence the Lewis acid catalyst to form a halohydrin intermediate. The process may further comprise a dehydrohalogenation reaction in which the halohydrin intermediate is reacted with the basic acting substance in the aqueous solution to form the epoxy resin.

Examples of the Lewis acid used in the Lewis acid catalyzed coupling reaction step of the Lewis acid catalyzed coupling/slurry epoxidation process include boron trifluoride or a boron trifluoride complex, such as boron trifluoride etherate, tin (IV) chloride, aluminum chloride, ferric chloride, zinc chloride, silicon tetrachloride, titanium tetrachloride, antimony trichloride; any mixtures thereof; or the like.

The amount of the Lewis acid used may range from about 0.00015 to about 0.015, preferably from about 0.00075 to about 0.0075, and more preferably from about 0.0009 to about 0.005 moles per mole of the OH or COOH functionalized fatty amide intermediate. The amount of the Lewis acid may also depend on particular reaction variables such as reaction time and reaction temperature.

In one embodiment of the Lewis acid catalyzed coupling reaction step of the Lewis acid coupling/epoxidation process, the coupling reaction involves adding the epichlorohydrin to a stirred mixture or solution of the OH or COOH functionalized fatty amide intermediate and the Lewis acid catalyst to produce an intermediate product comprising a halohydrin such as a chlorohydrin. Tin (IV) tetrachloride is particularly preferred as the Lewis acid catalyst. Once the reaction is complete, the resultant halohydrin intermediate is then reacted using the slurry epoxidation process, in a dehydrohalogenation reaction step, with sodium hydroxide as a solid.

In another embodiment, the resultant intermediate product obtained from the Lewis acid coupling reaction step is subsequently reacted using the slurry epoxidation process, in a dehydrohalogenation reaction step, with sodium hydroxide and anhydrous sodium sulfate as solids.

A catalyst other than the Lewis acid catalysts may also be used to prepare the epoxy resins. If used, the non-Lewis acid catalyst may be added at any time during the slurry epoxidation or anhydrous epoxidation processes, but is added only to the dehydrohalogenation reaction step (the slurry epoxidation process) of the Lewis acid catalyzed coupling/slurry epoxidation process.

In a manner similar to the Lewis acid catalyzed coupling reaction step described above, an alkali metal hydride may also be added to react with the functionalized fatty amide intermediate followed by the reaction of the resultant alkoxide with the epihalohydrin. Examples of the alkali metal hydride which may be used include sodium hydride, potassium hydride, and any mixture thereof or the like, with sodium hydride being the preferred alkali metal hydride. The intermediate product is then reacted in a dehydrohalogenation reaction step using the slurry epoxidation process with (d) a basic acting substance in a solid form. The process that employs the alkali metal hydride may also optionally comprise any one or more of the following components: (e) a solvent, (f) a catalyst other than the Lewis acid catalyst, and/or (g) a dehydrating agent.

The slurry epoxidation or anhydrous epoxidation processes may also be conducted in the absence of a solvent, with epichlorohydrin being used in an amount to function as both solvent and reactant. For example, the slurry epoxidation process may be conducted by reacting the functionalized fatty amide intermediate with the epihalohydrin in a ratio of from about 2 to about 3 equivalents of epihalohydrin per primary hydroxyl in the mixture. This slurry epoxidation process provides an easily mixed reaction slurry because the initial viscosity of the reaction slurry is low and the heat generated from the epoxidation process, including the heat from the reaction and heat from the stirring of the reaction mixture, can be easily transferred out of the reactor.

Any of the processes for preparing an epoxy resin of the present invention disclosed herein may also include a recovery and purification process. The recovery and purification can be performed, for example, using methods such as gravity filtration, vacuum filtration, vacuum distillation including rotary evaporation and fractional vacuum distillation, centrifugation, water washing or extraction, solvent extraction, decantation, column chromatography, vacuum distillation, falling film distillation, wiped film distillation, electrostatic coalescence, and other known recovery and purification processing methods; and any combination thereof; and the like. The process of recovering and purifying the epoxy resin may be a non-aqueous process. Falling film or wiped film distillation is a preferred method for the recovery and purification process of high purity (for example, greater than about 99%) epoxy resin of the present invention that is substantially free of oligomer. The term “free of oligomer” or “substantially free of oligomer” used herein means that the oligomer is present in the epoxy resin in a concentration of less than about 2 percent, preferably less than about 1 percent, and more preferably zero percent by weight based on the total weight of the epoxy resin final product.

The recovery and purification process comprises, for example, removing and recovering components with lower boiling points, including those components with boiling points below that of the epoxy resin of the OH or COOH functionalized fatty amide intermediate. Examples of these components include unreacted epihalohydrin and co-produced glycidyl ether (for example, 2-epoxypropyl ether) side-products. The recovered epihalohydrin may be recycled (for example, re-used as a reactant) and the diglycidyl ether side-product may be used for other purposes, such as a reactive intermediate product.

According to one embodiment of the present invention, the components, including those with boiling points below the epoxy resin of the OH or COOH functionalized fatty amide intermediate removed via vacuum distillation (such as rotary evaporation) until the total amounts of the components with boiling points below the epoxy resin of the functionalized saturated fatty acid fatty amide intermediate ester is less than about 0.5 percent by weight based on the total weight of the epoxy resin final product. If present, some of or all of the monoglycidyl ethers of the OH or COOH functionalized fatty amide intermediate may also be removed via vacuum distillation.

When none or a controlled amount of the monoglycidyl ethers of the functionalized saturated fatty acid esters are removed via distillation techniques, the process of the present invention produces an epoxy resin final product comprising the di- and polyglycidyl ethers of saturated fatty acid esters and fatty acid triglycerides, the monoglycidyl ethers of saturated fatty acid esters and fatty acid triglycerides, and one or more oligomers thereof.

When all of the monoglycidyl ethers of the fatty amide intermediate are removed via distillation, the process of the present invention produces an epoxy resin final product comprising di- and/or polyglycidyl ethers of saturated fatty acid esters and fatty acid triglycerides and oligomers thereof. Alternately, the reaction may directly provide an epoxy resin product comprising di- and/or polyglycidyl ethers of the fatty amide intermediate and one or more oligomers thereof essentially free of any monoglycidyl ethers.

In one embodiment of the present invention, during the recovery and purification process, the epoxy resin produced from the slurry epoxidation reaction may be centrifuged and/or filtered to remove solid salts (for example, unreacted sodium hydroxide and sodium chloride if epichlorohydrin is used). Components in the epoxy resin including those with boiling points below the epoxy resin of the OH or COOH functionalized fatty amide intermediate are removed via vacuum distillation to provide the epoxy resin final product of the present invention. This recovery and purification process is essentially a non-aqueous process, which has advantages over other recovery and purification processes using an aqueous solution. For example, in a non-aqueous process, the waste salt solids generated from the non-aqueous process can be easily recovered and disposed. In an aqueous process, however, the waste generated from the aqueous process is an aqueous liquid, which is more difficult to handle and dispose compared to the solid waste generated from the non-aqueous process.

In another embodiment, the epoxy resin solution obtained after centrifuging and/or filtration of the product from the slurry epoxidation my be washed with one or more washes of water or other aqueous solutions such as, for example, sodium hydrogen carbonate or sodium dihydrogen phosphate. This again allows for recovery of the bulk of the waste salts as an easily disposed solid concurrent with removal of traces of salts or other water soluble contaminants through the wash or washes that may be deleterious to the stability of the epoxy resin product or may. Likewise, washing can beneficially lower ionic chloride levels that may be present in the epoxy resin product.

Certain of the epoxy resins disclosed herein may be non-crystallizing at room temperature (for example, 25° C.) and may have the ability to accept high solid contents due to their inherent low viscosity. Additionally, the epoxy resins produced by the slurry epoxidation process or the anhydrous epoxidation process possess low chloride (including ionic, hydrolyzable and total chloride) contents. Such epoxy resins, having a low chloride content, have advantages which may include the following: (a) improved reactivity of the epoxy resins when cured with conventional epoxy resin curing agents, (b) increased di or polyglycidyl ether content, (c) reduced potential corrosivity of the epoxy resins, and (d) improved electrical properties of the epoxy resins. The epoxy resins produced by the Lewis acid coupling/epoxidation process may be slightly higher in total chloride content (for example, chloromethyl groups bound into the epoxy resin structures) compared to the slurry epoxidation process and the anhydrous epoxidation process, however, the Lewis acid catalyzed coupling reaction step has the advantage of being a relatively simple process.

According to one embodiment of the present invention, a curable epoxy resin composition may be prepared comprising (A) an epoxy resin of a seed oil based alkanolamide such as any of the aforementioned epoxy resins based on seed oil based alkanolamide described above, and (B) at least one curing agent and/or at least one curing catalyst therefore. In another embodiment of the present invention, the curable epoxy resin composition may optionally include an additional epoxy resin compound (C) in addition to, but different than, the epoxy resin of the seed oil based alkanolamide (A).

The term “curable” (also referred to as “thermosettable”) with reference to a composition means that the composition is capable of being subjected to conditions which will render the composition to a cured or thermoset state or condition.

The term “cured” or “thermoset” is defined by L. R. Whittington in Whittington's Dictionary of Plastics (1968) on page 239 as follows: “Resin or plastics compounds which in their final state as finished articles are substantially infusible and insoluble. Thermosetting resins are often liquid at some stage in their manufacture or processing, which are cured by heat, catalysis, or some other chemical means. After being fully cured, thermosets cannot be resoftened by heat. Some plastics which are normally thermoplastic can be made thermosetting by means of crosslinking with other materials.”

Component (A), the epoxy resin of a seed oil based alkanolamide, useful in the curable epoxy resin composition above may be any of the aforementioned epoxy resins based on seed oil based alkanolamides described above.

Component (B), the curing agent and/or catalyst useful for curing the curable epoxy resin composition comprising the epoxy resin of the seed oil based alkanolamide (A) alone; or a blend or mixture of the epoxy resin of the seed oil based alkanolamide (A) and the epoxy resin compound (C), may be any curing agents and/or catalysts known for curing epoxy resin.

In one embodiment, a curable epoxy resin composition may be made comprising (a) the epoxy resin composition, and (b) at least one curing agent and/or at least one curing catalyst; wherein the curing agent comprises a material having at least one reactive hydrogen atom per molecule, and the epoxy resin composition comprises at least one epoxide group, and the reactive hydrogen atom in the curing agent is reactive with the epoxide group in the epoxy resin reactive diluent composition.

Examples of the curing agent include aliphatic, cycloaliphatic, polycycloaliphatic or aromatic primary monoamines; aliphatic, cycloaliphatic, polycycloaliphatic or aromatic primary and secondary polyamines; carboxylic acids and anhydrides thereof; aromatic hydroxyl containing compounds; imidazoles; guanidines; urea-aldehyde resins; melamine-aldehyde resins; alkoxylated urea-aldehyde resins; alkoxylated melamine-aldehyde resins; amidoamines; epoxy resin adducts; and any combinations thereof.

Particularly suitable curing agents include, for example, methylenedianiline; isophoronediamine; 4,4′-diaminostilbene; 4,4′-diamino-α-methylstilbene; 4,4′-diaminobenzanilide; dicyandiamide; ethylenediamine; diethylenetriamine; triethylenetetramine; tetraethylenepentamine; urea-formaldehyde resins; melamine-formaldehyde resins; methylolated urea-formaldehyde resins; methylolated melamine-formaldehyde resins; phenol-formaldehyde novolac resins, cresol-formaldehyde novolac resins, sulfanilamide, diaminodiphenylsulfone, diethyltoluenediamine; t-butyltoluenediamine; bis-4-aminocyclohexylamine; isophoronediamine; diaminocyclohexane; hexamethylenediamine; piperazine; aminoethylpiperazine; 2,5-dimethyl-2,5-hexanediamine; 1,12-dodecanediamine; tris-3-aminopropylamine; and any combinations thereof.

Examples of suitable curing catalysts include boron trifluoride, boron trifluoride etherate, aluminum chloride, ferric chloride, zinc chloride, silicon tetrachloride, stannic chloride, titanium tetrachloride, antimony trichloride, boron trifluoride monoethanolamine complex, boron trifluoride triethanolamine complex, boron trifluoride piperidine complex, pyridine-borane complex, diethanolamine borate, zinc fluoroborate, metallic acylates such as stannous octoate or zinc octoate, and any mixtures thereof.

The curing agent may be employed in an amount which will effectively cure the curable epoxy resin composition, however, the amount of the curing agent will also depend upon the particular components present in the curable epoxy resin composition, for example, the epoxy resin reactive diluent, the epoxy resin, the type of curing agent and/or catalyst employed.

Generally, a suitable amount of curing agent may range from about 0.80:1 to about 1.50:1, and preferably from about 0.95:1 to about 1.05:1 equivalents of reactive hydrogen atom in the curing agent per equivalent of epoxide group in the epoxy resin. The reactive hydrogen atom is the hydrogen atom which is reactive with an epoxide group in the epoxy resin.

Similarly, the curing catalyst is also employed in an amount which will effectively cure the curable epoxy resin composition; however, the amount of the curing catalyst will also depend upon particular components present in the curable epoxy resin composition, for example, the epoxy resin of the seed oil based alkanolamide (A), the epoxy resin compound (C), the type of curing agent and/or catalyst employed.

Generally, a suitable amount of the curing catalyst from about 0.0001 to about 2 percent, and preferably from about 0.01 to about 0.5 percent by weight based on the total weight of the curable epoxy resin composition may be employed.

One or more of the curing catalysts may be employed in the process of curing of the curable epoxy resin composition in order to accelerate or otherwise modify the curing process.

Component (A), the epoxy resin of the seed oil based alkanolamide of the present invention, useful in the curable epoxy resin composition above may be used alone or may be combined with one or more different optional epoxy resins, Component (C), to form a mixture or blend of epoxy resins. Accordingly, the present invention also comprises a curable epoxy resin blend composition comprising the epoxy resin of the seed oil based alkanolamide, the epoxy resin (A) of the present invention, such as the glycidyl ether amides and glycidyl ester amides described above; the epoxy resin compound (C), and at least one curing agent and/or at least one curing catalyst (B) therefore. In a blend of epoxy resins, the weight ratio of glycidyl ethers and glycidyl esters described above to other epoxy resins (C) in a composition may range from about 1:0 to about 0.05:0.95, and preferably from about 0.4:0.6 to about 0.7:0.3.

The epoxy resins which may be used as the epoxy resin compound (C) may be any epoxide-containing compound which has an average of more than one epoxide group per molecule. The epoxide group can be attached to any oxygen, sulfur or nitrogen atom or the single bonded oxygen atom attached to the carbon atom on a —CO—O— group. The oxygen, sulfur, nitrogen atom, or the carbon atom of the —CO—O— group may be attached to an aliphatic, cycloaliphatic, polycycloaliphatic or aromatic hydrocarbon group. The aliphatic, cycloaliphatic, polycycloaliphatic or aromatic hydrocarbon group can be substituted with any inert substituents including, but not limited to, halogen atoms, preferably fluorine, bromine or chlorine; nitro groups; or the groups can be attached to the terminal carbon atoms of a compound containing an average of more than one —(O—CHR^{a}—CHR^{a})ₜ— group, wherein each R^{a} is independently a hydrogen atom or an alkyl or haloalkyl group containing from one to two carbon atoms, with the proviso that only one R^{a} group can be a haloalkyl group, and t has a value from one to about 100, preferably from one to about 20, and more preferably from one to about 10, most preferably from one to about 5.

More specific examples of the epoxy resin suitable for the epoxy resin compound (C) include diglycidyl ethers of 1,2-dihydroxybenzene (catechol); 1,3-dihydroxybenzene (resorcinol); 1,4-dihydroxybenzene (hydroquinone); 4,4′-isopropylidenediphenol (bisphenol A); hydrogenated bisphenol A; 4,4′-dihydroxydiphenylmethane; 3,3′,5,5′-tetrabromobisphenol A; 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1′-bis(4-hydroxyphenyl)-1-phenylethane; 3,3′-5,5′-tetrachlorobisphenol A; 3,3′-dimethoxybisphenol A; 4,4′-dihydroxybiphenyl; 4,4′-dihydroxy-α-methylstilbene; 4,4′-dihydroxybenzanilide; 4,4′-dihydroxystilbene; 4,4′-dihydroxy-α-cyanostilbene; N,N′-bis(4-hydroxyphenyl)terephthalamide; 4,4′-dihydroxyazobenzene; 4,4′-dihydroxy-2,2′-dimethylazoxybenzene; 4,4′-dihydroxydiphenylacetylene; 4,4′-dihydroxychalcone; 4-hydroxyphenyl-4-hydroxybenzoate; dipropylene glycol, 1,4-butanediol, neopentyl glycol, poly(propylene glycol), thiodiglycol; the triglycidyl ether of tris(hydroxyphenyl)methane; the polyglycidyl ethers of a phenol or alkyl or halogen substituted phenol-aldehyde acid catalyzed condensation product (novolac resins); the tetraglycidyl amines of 4,4′-diaminodiphenylmethane; 4,4′-diaminostilbene; N,N′-dimethyl-4,4′-diaminostilbene; 4,4′-diaminobenzanilide; 4,4′-diaminobiphenyl; the polyglycidyl ether of the condensation product of a dicyclopentadiene or an oligomer thereof and a phenol or alkyl or halogen substituted phenol; and any combination thereof.

One embodiment of the epoxy resin composition comprises a mixture of (a) the epoxy amide of the present invention; and (b) a mono- or polyvalent glycidyl sulfide, glycidyl amine, N-(glycidyl) amide, a glycidyl ether not represented by Formula I, or a glycidyl ester not represented by Formula I. The glycidyl ether in component (b) of epoxy resin composition may be the diglycidyl ether of bisphenol A, diglycidyl ether of 4,4′-dihyroxydiphenol methane, hydroquinone, or resorcinol. Generally, about 10 wt % to about 40 wt % of the composition's total weight may comprise the epoxy amide.

The epoxy resin which can be used as the epoxy resin compound (C) may also include an advancement reaction product of an epoxy resin with an aromatic di- and polyhydroxyl or carboxylic acid containing compound. The epoxy resin used for reacting with the aromatic di- and polyhydroxyl or carboxylic acid containing compound may include difunctional glycidyl ethers or esters of seed oil alkanolamides. A representative example is the difunctional glycidyl ester based on the aminol ysis reaction of reductively hydroformylated methyl oleate and n-alkyl ethanolamine).

Examples of the aromatic di- and polyhydroxyl or carboxylic acid containing compound include hydroquinone, resorcinol, catechol, 2,4-dimethylresorcinol; 4-chlororesorcinol; tetramethylhydroquinone; bisphenol A (4,4′-isopropylidenediphenol); 4,4′-dihydroxydiphenylmethane; 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1-bis(4-hydroxyphenyl)-1-phenylethane; 4,4′-bis(4(4-hydroxyphenoxy)-phenylsulfone)diphenyl ether; 4,4′-dihydroxydiphenyl disulfide; 3,3′,3,5′-tetrachloro-4,4′-isopropylidenediphenol; 3,3′,3,5′-tetrabromo-4,4′-isopropylidenediphenol; 3,3′-dimethoxy-4,4′-isopropylidenediphenol; 4,4′-dihydroxybiphenyl; 4,4′-dihydroxy-α-methylstilbene; 4,4′-dihydroxybenzanilide; bis(4-hydroxyphenyl)terephthalate; N,N′-bis(4-hydroxyphenyl)terephthalamide; bis(4′-hydroxybiphenyl)terephthalate; 4,4′-dihydroxyphenylbenzoate; bis(4′-hydroxyphenyl)-1,4-benzenediimine; 1,1′-bis(4-hydroxyphenyl)cyclohexane; phloroglucinol; pyrogallol; 2,2′,5,5′-tetrahydroxydiphenylsulfone; tris(hydroxyphenyl)methane; dicyclopentadiene diphenol; tricyclopentadienediphenol; terephthalic acid; isophthalic acid; 4,4′-benzanilidedicarboxylic acid; 4,4′-phenylbenzoatedicarboxylic acid; 4,4′-stilbenedicarboxylic acid; adipic acid; and any combination thereof.

In one embodiment, an oligomer may be formed by advancing the glycidyl amide of the present invention with a polyvalent nucleophile; wherein the polyvalent nucleophile may be a phenol, a carboxylic acid, an amine, a thiol or an alchohol. In one embodiment, the epoxy resin composition may be prepared by mixing (a) the oligomer in combination with (b) an epoxy amide or an epoxy resin composition. The epoxy resin may be the diglycidyl ether of bisphenol A, diglycidyl ether of 4,4′-dihyroxydiphenol methane, hydroquinone or resorcinol.

Preparation of the aforementioned advancement reaction products may be performed using known methods, which usually include combining an epoxy resin with one or more suitable compounds having an average of more than one reactive hydrogen atom per molecule. The reactive hydrogen atom is the hydrogen atom which is reactive with an epoxide group in the epoxy resin. The ratio of the compound having more than one reactive hydrogen atom per molecule to the epoxy resin is generally from about 0.01:1 to about 0.95:1, preferably from about 0.05:1 to about 0.8:1, and more preferably from about 0.10:1 to about 0.5:1 equivalents of the reactive hydrogen atom per equivalent of the epoxide group in the epoxy resin.

Examples of these advancement reaction products may include dithiols, disulfonamides, or compounds containing one primary amine or amide group, two secondary amine groups, one secondary amine group and one phenolic hydroxy group, one secondary amine group and one carboxylic acid group, or one phenolic hydroxy group and one carboxylic acid group, and any combination thereof.

The advancement reaction may be conducted, in the presence or absence of a solvent, with the application of heat and mixing. The advancement reaction may be conducted at atmospheric, superatmospheric, or subatmospheric pressures and at temperatures of from about 20° C. to about 260° C., preferably, from about 80° C. to about 240° C., and more preferably from about 100° C. to about 200° C.

The time required to complete the advancement reaction depends upon the factors such as the temperature employed, the chemical structure of the compound having more than one reactive hydrogen atom per molecule employed, and the chemical structure of the epoxy resin employed. Higher temperature may require shorter reaction time whereas lower temperature require longer period of the reaction time.

In general, the time for the advancement reaction completion may be ranged from about 5 minutes to about 24 hours, preferably from about 30 minutes to about 8 hours, and more preferably from about 30 minutes to about 4 hours.

A catalyst may also be added in the advancement reaction. Examples of the catalyst may include phosphines, quaternary ammonium compounds, phosphonium compounds and tertiary amines. The catalyst may be employed in quantities from about 0.01 to about 3, preferably from about 0.03 to about 1.5, and more preferably from about 0.05 to about 1.5 percent by weight based upon the total weight of the epoxy resin.

Other details concerning an advancement reaction useful in the present invention are given in U.S. Pat. No. 5,736,620 and Handbook of Epoxy Resins by Henry Lee and Kris Neville, incorporated herein by reference.

The epoxy resin of the seed oil based alkanolamide (A) may be added to the epoxy resin compound (C) in a functionally equivalent amount. For example, the epoxy resin (A) may be added in quantities which will provide the epoxy resin composition with a range of desired properties for example resistance to ultraviolet radiation, increased impact resistance, etc. according to the specific end use intended for the epoxy resin composition.

In one embodiment, an epoxy resin composition may be prepared by mixing (a) an epoxy amide comprising a glycidyl ether amide derived from at least one seed oil based alkanolamide, and (b) one or more epoxy resins other than the epoxy resin (a); wherein the seed oil based alkanolamide comprises at least one of a fatty acid ester, a fatty acid and a fatty acid triglyceride.

In general, the epoxy resin of the seed oil based alkanolamide (A) may be employed in an amount from about 0.5 to about 99 percent, preferably from about 5 to about 55 percent, and more preferably from about 10 to about 40 percent based upon the total weight of the epoxy resin composition.

The curable epoxy resin composition may also be blended with at least one or more optional additives including, for example, a cure accelerator, a solvent, a diluent (including non-reactive diluents, monoepoxide diluents, and reactive non-epoxide diluents), a modifier such as a flow modifier or a thickener, a reinforcing agent, a filler, a pigment, a dye, a mold release agent, a wetting agent, a stabilizer, a fire retardant agent, a surfactant, or any combination thereof.

These additives may be added in functionally equivalent amounts, for example, the pigment and/or dye may be added in quantities which will provide the composition with the desired color. In general, the amount of the additives may be from about zero to about 20, preferably from about 0.5 to about 5, and more preferably from about 0.5 to about 3 percent by weight based upon the total weight of the curable epoxy resin composition.

The cure accelerator which may be used herein includes, for example, mono, di, tri and tetraphenols; chlorinated phenols; aliphatic or cycloaliphatic mono or dicarboxylic acids; aromatic carboxylic acids; hydroxybenzoic acids; halogenated salicylic acids; boric acid; aromatic sulfonic acids; imidazoles; tertiary amines; aminoalcohols; aminopyridines; aminophenols, mercaptophenols; and any mixture thereof.

Particularly suitable cure accelerators include 2,4-dimethylphenol, 2,6-dimethylphenol, 4-methylphenol, 4-tertiary-butylphenol, 2-chlorophenol, 4-chlorophenol, 2,4-dichlorophenol, 4-nitrophenol, 1,2-dihydroxybenzene, 1,3-dihydroxybenzene, 2,2′-dihydroxybiphenyl, 4,4′-isopropylidenediphenol, valeric acid, oxalic acid, benzoic acid, 2,4-dichlorobenzoic acid, 5-chlorosalicylic acid, salicylic acid, p-toluenesulfonic acid, benzenesulfonic acid, hydroxybenzoic acid, 4-ethyl-2-methylimidazole, 1-methylimidazole, triethylamine, tributylamine, N,N-diethylethanolamine, N,N-dimethylbenzylamine, 2,4,6-tris(dimethylamino)phenol, 4-dimethylaminopyridine, 4-aminophenol, 2-aminophenol, 4-mercaptophenol, or any combination thereof.

Examples of the solvent which may be used herein include, for example, aliphatic and aromatic hydrocarbons, halogenated aliphatic hydrocarbons, aliphatic ethers, aliphatic nitriles, cyclic ethers, glycol ethers, esters, ketones, amides, sulfoxides, and any combination thereof.

Particularly suitable solvents include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, diethylene glycol methyl ether, dipropylene glycol methyl ether, N-methylpyrrolidinone, N,N-dimethylacetamide, acetonitrile, sulfolane, and any combination thereof.

The curable epoxy resin composition may further comprise a diluent; wherein the diluent comprises at least one of non-reactive diluent, monoepoxide diluent, diluent other than the epoxy resin composition, reactive non-epoxide diluent, and any combination thereof.

Examples of diluents which may be used herein include, for example, dibutyl phthalate, dioctyl phthalate, styrene, low molecular weight polystyrene, styrene oxide, allyl glycidyl ether, phenyl glycidyl ether, butyl glycidyl ether, vinylcyclohexene oxide, neopentylglycol diglycidyl ether, butanediol diglycidyl ether, hexanediol diglycidyl ether, diethylene glycol diglycidyl ether, dipropylene glycol diglycidyl ether, poly(propylene glycol) diglycidyl ether, thiodiglycol diglycidyl ether, maleic anhydride, ∈-caprolactam, butyrolactone, acrylonitrile, and any combination thereof.

Particularly suitable diluents include, for example, the epoxy resin diluents such as the aforementioned neopentylglycol diglycidyl ether, butanediol diglycidyl ether, hexanediol diglycidyl ether, diethylene glycol diglycidyl ether, dipropylene glycol diglycidyl ether, poly(propylene glycol) diglycidyl ether, thiodiglycol diglycidyl ether, and any combination thereof.

The modifier such as thickener and flow modifier may be employed in amounts of from zero to about 10, preferably, from about 0.5 to about 6, and more preferably from about 0.5 to about 4 percent by weight based upon the total weight of the curable epoxy resin composition.

The reinforcing material which may be employed herein includes natural and synthetic fibers in the form of woven fabric, mat, monofilament, multifilament, unidirectional fiber, roving, random fiber or filament, inorganic filler or whisker, or hollow sphere. Other suitable reinforcing material includes glass, carbon, ceramics, nylon, rayon, cotton, aramid, graphite, polyalkylene terephthalates, polyethylene, polypropylene, polyesters, and any combination thereof.

The filler which may be employed herein includes, for example, inorganic oxide, ceramic microsphere, plastic microsphere, glass microsphere, inorganic whisker, calcium carbonate, and any combination thereof.

The filler may be employed in an amount from about zero to about 95, preferably from about 10 to about 80 percent, and more preferably from about 40 to about 60 percent by weight based upon the total weight of the curable epoxy resin composition.

According to the present invention, cured epoxy resins may be prepared by a process of curing the curable epoxy resin composition described above.

The process of curing of the curable epoxy resin compositions described herein may be conducted at atmospheric, superatmospheric or subatmospheric pressures and at temperatures of from about 0° C. to about 300° C., preferably from about 25° C. to about 250° C., and more preferably from about 25° C. to about 200° C.

The time required to complete the process of curing the curable epoxy resin composition depends upon the temperature employed. Higher temperature requires shorter curing time whereas lower temperatures require longer curing time. Generally, the process may be completed in about 1 minute to about 48 hours, preferably from about 15 minutes to about 24 hours, and more preferably from about 30 minutes to about 12 hours.

It is also operable to partially cure (B-stage) the curable epoxy resin composition of the present invention to form a B-stage product and subsequently cure the B-stage product completely at a later time.

Certain of the epoxy resin compositions described herein may possess relatively low viscosity without the use of solvent and may not exhibit crystallization at room temperature, even after prolonged storage time. Additionally, if the epoxy resin composition comprises a low chloride (ionic, hydrolyzable and total) form of the epoxy resin, the resultant curable epoxy resin composition will also possess low chloride content, which can provide increased reactivity toward conventional epoxy resin curing agents, higher inherent di or polyglycidyl ether content, reduced potential corrosivity, and improved electrical properties for cured parts.

The cured epoxy resins described herein may exhibit improvements in physical and mechanical properties. For example, the cured epoxy resin may have one or more of a high glass transition temperature, improved moisture and corrosion resistance, improved UV stability, improved coating properties and compatibility with conventional epoxy resin curing agents.

As also shown in the following examples, coatings prepared using the epoxy resin composition exhibit better coating quality, improved resistance to methylethylketone, increased hardness, higher impact resistance and bending resistance, no loss of adhesion, resistance to ultraviolet radiation (non-chalking coatings), and maintenance of rapid cure, relative to the corresponding coatings prepared using an epoxy resin of bisphenol A glycidyl ether alone.

The epoxy resins or the cured epoxy resins of the present invention may be useful in coatings, especially protective coatings which provide solvent resistant, moisture resistant, abrasion resistant, and weatherable properties; electrical or structural laminate or composite; filament windings; moldings; castings; encapsulation; stabilizer additives for plastics; and the like.

### EXAMPLES

The following standard analytical equipment and methods are used in the Examples and Comparative Experiment

A Hewlett Packard 5890 Series II Plus gas chromatograph was employed using a DB-1 capillary column (61.4 m by 0.25 mm, Agilent). The column was maintained in the chromatograph oven at a 50° C. initial temperature. Both the injector inlet and flame ionization detector were maintained at 300° C. Helium carrier gas flow through the column was maintained at 1.1 milliliters per min. The temperature program employed a two minutes hold time at 50° C., a heating rate of 10° C. per min to a final temperature of 300° C., and a hold time at 300° C. of 15 minutes. When a sample was analyzed with oligomers that did not elute from the column, the chromatograph oven was held at 300° C. prior to analysis of the next sample until the residual oligomers had “burned off.” All GC analyses in the following Examples are measured in area %, and as such are not a quantitative measure of any given component.

Samples for GC analysis were prepared by collection of a 0.5 milliliter aliquot of an epoxy resin product from the epoxidation process and addition to a vial containing 1 milliliter of acetonitrile. A portion of the product in acetonitrile was mixed then loaded into a 1 milliliter syringe (Norm-Ject, all polypropylene/polyethylene, Henke Sass Wolf GmbH) and passed through a syringe filter (Acrodisc CR 13 with 0.2 μm PTFE membrane, Pall Corporation, Gelman Laboratories) to remove any inorganic salts or debris.

Hydrolyzable chloride generally results from a coupling product (for example chlorohydrin intermediate) which has not cyclized via dehydrochlorination with sodium hydroxide to give the epoxide ring during the epoxidation process. Ionic chloride includes sodium chloride co-product from the epoxidation process which has been entrained in the epoxy resin product. Sodium chloride is co-produced in the dehydrochlorination of a chlorohydrin with sodium hydroxide. Total chloride accounts for the chlorine bound into the epoxy resin structure in the form of a chloromethyl group. The chloromethyl group forms as a result of a coupling reaction of a secondary hydroxyl group in a chlorohydrin intermediate with epichlorohydrin. The ionic and hydrolyzable and total chlorides were determined using titration methods while the total chloride was determined via X-ray fluorescence analysis.

A standard titration method was used to determine percent epoxide in the various epoxy resins. A sample was weighed (ranging from about 0.1-0.2 grams) and dissolved in dichloromethane (15 milliliters). Tetraethylammonium bromide solution in acetic acid (15 milliliters) was added to the sample. The resultant solution was treated with 3 drops of crystal violet solution (0.1% w/v in acetic acid) and was titrated with 0.1N perchloric acid in acetic acid on a Metrohm 665 Dosimat titrator (Brinkmann). Titration of a blank sample comprising dichloromethane (15 milliliters) and tetraethylammonium bromide solution in acetic acid (15 milliliters) provided correction for solvent background. General methods for this titration are found in scientific literature, for example, Jay, R. R., “Direct Titration of Epoxy Compounds and Aziridines”, Analytical Chemistry, 36, 3, 667-668 (March, 1964).

A Fisher Multiscope thickness tester was used to determine thickness of the non-magnetic coatings deposited on ferromagnetic substrates. The Fisher Multiscope includes a probe and operates via magnetic induction to indicate coating thickness after placing the probe against the coating and activating the Multiscope. Coating thickness values reported herein represent an average of 15 coating thickness measurements.

The % hydroxyl (also known as Hydroxy Number) was determined using ASTM Method D 4274. To determine the % hydroxyl of a sample, a sample was dissolved in pyridine and titrated via a potentiometric method using 1.0 N aqueous sodium hydroxide after the addition of a known excess of phthalic anhydride in pyridine had been added.

The film hardness using the pencil test was determined in accordance with ASTM Method D 3363. A coated panel was placed on a firm horizontal surface. The operator then holds a pencil of known hardness firmly against the coating or film at a 45° angle and pushes the pencil away from the operator's body in a ¼ inch (6.5 mm) stroke. The test is begun with the softest lead pencil (6B) and is continued with pencils of progressively harder lead (toward 9H) until the stroke causes the pencil to cut into or gouge the film or coating. The coating pencil hardness is reported by the hardness of the lead of that pencil immediately preceding the pencil that cuts into or gouges the coating.

ASTM Method D 5402 was used to determine the methyl ethyl ketone (MEK) double rubs. The rounded end (peen) of a two pound (4.4 kilograms) ball-peen hammer covered with 8 ply gauze soaked in MEK is passed back and forth over the surface of a coated panel until the coating fails. Only the weight of the hammer and that force needed to guide the gauze-covered peen across the coating are used in this test. Coating failure occurs upon exposure of panel substrate beneath the coating. Acidic copper sulfate is used to verify substrate exposure and coating failure. The test is replicated several times and the arithmetic mean of such testing is reported as the “MEK Double Rub Failure Number”.

The ⅛ inch conical mandrel bend test in accordance with ASTM Method D 522-93a was used to determine flexibility. The flexibility (resistance to cracking) is measured for organic coatings attached to a sheet metal substrate having a thickness of no more than 1/32 inch (0.8 mm) using test equipment supplied by Gardner Lab, Inc. This test equipment consists of a smooth metal conical mandrel (length of 8 inches (20.3 cm), a small end diameter of ⅛ inch (3.2 mm) and a large end diameter of 1.5 inch (38.1 mm), a rotating panel-bending arm, and panel clamps, all mounted on a metal base. A coated sheet metal substrate is clamped into the apparatus and bent approximately 135° from vertical. The coated metal substrate is examined proximate to the bend for cracks and, if present, the crack length is measured from the small end of the conical mandrel. The measured crack length is reported as “failure distance”.

A cross hatch adhesion test in accordance with ASTM D 3359-90, Test Method B was used to test cured coatings. An 11-blade knife is used to cut a cured coating deposited on a panel to produce three cross-hatched sections. A strip of masking tape is firmly pressed to each cross-hatched section and then quickly removed. The coating is examined with a magnifying glass to determine how much, if any, of the coating has been removed with the masking tape. The coating is given a rating of “pass” when cut edges appear to be completely smooth and none of the coating is removed from inside squares of the cross-hatched section. A rating of “failure” is given when at least a portion of the coating appears to be absent proximate to cut junctures or from interior portions of the cross-hatched section or both.

The resistance of organic coatings to the effects of rapid deformation (impact) was determined using ASTM Method D 2794 Direct Impact and Reverse Impact. A standard weight (four pounds (8.8 kg) is dropped a distance onto an indenter that deforms both the cured film and the substrate or panel underlying the cured film or coating. The indenter can be placed either against the cured film to impose an intrusion and evaluate resistance to direct impact or against the substrate or panel surface opposite that on which the cured coating is bonded to impose an extrusion force to evaluate resistance to a reverse impact. The distance the weight drops is gradually increased until reaching a distance at which coating failure occurs. Cured films or coatings generally fail by cracking, which becomes more visibly evident when viewed through a magnifier, especially after one applies an acidic copper sulfate solution to the cured film or coating after deformation.

Gloss was determined using ASTM Method D 523. A Gardner Micro Tri Gloss Meter was used to make spectral gloss measurements (percent light reflectance) at angles of 20°, 60° and 85° from the coating's horizontal surface. An average for gloss measurements at each of these angles was reported.

QUVA testing of coatings was done using ASTM Method G 53. After curing, the gloss of the coatings was measured using a gloss meter according to ASTM method D 523. The panels were then placed in an apparatus described in ASTM Method G 53 in which they were alternately exposed to 4 hours of ultraviolet light at 60° C. and to 4 hours of water condensation at 50° C. in a repetitive cycle. The ultraviolet irradiation in this apparatus was from an array of UV-A type lamps operating at a wavelength of 340 nm. To determine the effect of these conditions on the gloss, the panels were briefly removed from the apparatus, approximately, every 100 hours and measurements were made.

The following Examples and Comparative Experiment further illustrate the present invention in detail but are not to be construed to limit the scope thereof.

### Example 1

### A. Preparation of an Amide Polyol from Diethanolamine and Castor Oil

Castor oil (200.07 grams) and diethanolamine (276.03 grams, 2.62 moles) were placed in a 2 liter round bottom flask equipped with mechanical stirring and a reflux condenser. The flask was seated in an electric heating mantle. The heating mantle was controlled by a temperature controller with a thermocouple immersed into a glass well in contact with the flask contents. The stirred reaction flask contents were heated to 120° C. The mixture was stirred at 120° C. overnight. The next morning, a sample was taken for fourier transform infrared (FTIR) spectrophotometric analysis which showed a trace amount of ester absorbance at 1733 cm⁻¹. The reaction mixture was then allowed to cool to ambient temperature and one kilogram of chloroform was added. The chloroform solution was then washed 4 times with 400 grams of aqueous 2% NaCl. The washed chloroform solution was dried over anhydrous magnesium sulfate and filtered. The filtrate was rotary evaporated for 5 hours at 60° C. and 2.3 millimeters of Hg to remove the chloroform. The final product was a liquid at ambient temperature. FTIR spectrophotometric analysis and ¹H NMR analysis supported the ricinolamide triol structure given below. The % OH for this material was 12 56.

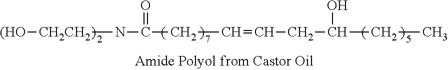

### B. Synthesis of a Polyglycidyl Ether of a Castor Oil Amide Polyol

A portion (95 grams) of the castor oil amide polyol from Example 1 Part A above was added to a glass bottle along with toluene (250 milliliters) and dissolved to form a solution. Sodium sulfate (granular, anhydrous) (30 grams) was added to the solution followed by gentle mixing for 4 hours on a mechanical shaker. The resultant product slurry was filtered through a bed of fresh sodium sulfate (granular, anhydrous) (40 grams) supported in a coarse fritted glass funnel with additional toluene (75 milliliters) used to wash the product remaining in the contents of the filter into the filtrate. Rotary evaporation of the filtrate using a maximum oil bath temperature of 120° C. provided the dry castor oil amide polyol (93 grams).

A one liter, three neck, glass, round bottom reactor was charged under nitrogen with epichlorohydrin (185.0 grams. 2.0 moles), sodium hydroxide (pellets, anhydrous, reagent grade, ≧98%) (44.0 grams, 1.10 moles), and sodium sulfate (granular, anhydrous) (99.4 grams, 0.70 mole). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft. variable speed motor). Pre-warmed dry castor oil amide polyol (66.5 grams, 0.491 —OH equivalents) was added to a side arm vented addition funnel then attached to the reactor. Stirring commenced to give a 25° C. slurry of sodium hydroxide and sodium sulfate in epichlorohydrin. After stirring for 7 minutes, heating of the reactor commenced using a thermostatically controlled heating mantle. Once the stirred slurry equilibrated at 40° C., an initial aliquot of castor oil amide polyol (3 milliliters) was added to the reactor. The reaction temperature was maintained at 40° C. during the addition of the aliquots unless otherwise noted. The aliquots were added, as follows:

| Cumulative time | | |
|---|---|---|
| from Addition | Amount of Aliquot | |
| of 1^{st} Aliquot (minutes) | (milliliters) | Observations |
| 10 | 10 | |
| 30 | 10 | Light foaminess of |
| | | surface slurry |
| 50 | 10 | Cloudy light yellow |
| | | colored slurry |
| 75 | 10 | Exotherms to 41° C. |
| | | within 2 minutes |
| 95 | 10 | |
| 115 | 10 | |
| 135 | 5 | |

The progress of the epoxidation reaction was monitored by high pressure liquid chromatography (HPLC). After a cumulative 41 hours of reaction, heating of the thin, tan colored slurry ceased followed by addition of methylisobutylketone (MIBK) (400 milliliters) and cooling of the reactor exterior to 25° C. with a fan. The MIBK slurry was vacuum filtered over a one inch pad of diatomaceous earth supported on a 600 milliliter coarse fritted glass funnel. Rotary evaporation of the filtrate using a maximum oil bath temperature of 70° C. provided 102.17 grams of light amber colored, slightly hazy liquid. The solids remaining on top of the diatomaceous earth were collected into a bottle containing fresh MIBK (400 milliliters), and then placed on the mechanical shaker for one hour. The MIBK slurry was then vacuum filtered through the diatomaceous earth pad followed by rotary evaporation of the additional filtrate to give a cumulative 102.70 grams of product. Further rotary evaporation at 140° C. for one hour gave 96.19 grams of product as a transparent, yellow colored liquid. GC analysis revealed that essentially all light boiling components, including residual epichlorohydrin and diglycidyl ether co-product had been removed. HPLC analysis revealed 100% conversion of the castor oil amide polyol to products. Titration of a pair of aliquots of the product obtained demonstrated and average of 18.56% epoxide (231.84 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1643.7 cm⁻¹ for the polyglycidyl ether and 1622.7 cm⁻¹ for the polyol reactant,

(2) conversion of hydroxyl groups at 3373.4 cm⁻¹ in the polyol reactant with only a minor hydroxyl absorbance present in the polyglycidyl ether at 3438.4 cm⁻¹,

(3) appearance of a strong aliphatic ether C—O stretch at 1111.8 cm⁻¹ in the polyglycidyl ether, and

(4) appearance of epoxide ether C—O stretch at 1253.3 cm⁻¹, 910.7 cm⁻¹ and 849.1 cm⁻¹ in the polyglycidyl ether.

Both the polyol reactant and the polyglycidyl ether product possessed a very minor absorbance (1734.0 cm⁻¹ and 1731.4 cm⁻¹, respectively) which may be indicative of a slight amount of ester functionality.

The progress of the epoxidation reaction was monitored by HPLC analysis, with the results shown in following table. “None” for the cumulative reaction time designates the castor oil amide polyol reactant used in the epoxidation reaction. “Final” designates the product recovered after completion of the work-up (rotary evaporation at 140° C.)

| | Cumulative Reaction Time | | | | | |
|---|---|---|---|---|---|---|
| | After Completion of Castor | | | | | |
| Retention Time of | Oil Amide Polyol | | | | | |
| Components Present at | (area percent) | | | | | |
| ≧3 area % (min) | None | 5 min | 15.5 hr | 22.1 hr | 38.6 hr | Final |
| 3.12 | 0 | 34.21 | 0 | 0 | 0 | 0 |
| 3.85 | 0 | 33.28 | 31.64 | 25.09 | 25.23 | 30.21 |
| 3.91 | 83.63 | 0 | 0 | 0 | 0 | 0 |
| 4.99 | 0 | 0 | 32.85 | 33.06 | 35.75 | 43.45 |
| 6.40 | 0 | 4.82 | 7.73 | 7.96 | 8.37 | 9.30 |
| 6.51 | 0 | 3.34 | 0 | 0 | 0 | 0 |
| 7.17 | 3.99 | 0 | 0 | 0 | 0 | 0 |
| 8.12 | 0 | 0 | 3.89 | 3.06 | 3.86 | 4.29 |
| 9.14 | 3.84 | 0 | 0 | 0 | 0 | 0 |

### Example 2

Preparation and Testing of Coatings Based on the Glycidyl Ether from Example 1 Part B

Castor oil amide polyol glycidyl ether from Example 1 Part B (20.0 grams, 0.0863 equivalents), D.E.R.™ 331 epoxy resin, a bisphenol A diglycidyl ether by The Dow Chemical Company (10.00 grams, 0.0531 equivalents), Ancamide™ 2353 curing agent (15.89 grams, 0.1394 equivalents, available from Air Products), and 3 drops of BYK™310 were combined in a glass bottle. These components were then stirred to obtain a homogeneous, transparent liquid. From this liquid, coatings were drawn down on 0.03 inch by 4 inch by 12 inch polished, cold roll steel panels using a #48 draw down bar from BYK Chemie USA. This formulation was also applied to 3 inch by 6 inch unpolished, coil coat white panels using a

10 mil draw down bar (also from BYK Chemie). The coatings were then cured for 7 days at ambient conditions and were then post cured for 24 hours at 140° F. in a forced air convection oven. After cure, the coating thicknesses were measured using a Fisherscope Film Thickness Meter. The coatings were then tested. The properties obtained from the testing of the coatings on the cold roll steel panels are given in Table 1 and those from the QUVA testing of the coatings on the coil coat white panels are given in Table 2.

### Example 3

### A. Preparation of an Amide Polyol from Diethanolamine and Reductively Hydroformylated Soybean Oil Methyl Esters (3.3 Average Hydroxyl Functionality)

Methyl esters containing primary methyl hydroxyl groups in the backbone which were obtained by the reductive hydroformylation of soybean oil (400.00 grams, 1.3 average hydroxyl functionality), 0.916 grams of 85% KOH, and diethanolamine (514.33 grams; 4.86 moles) were placed in a 3 liter round bottom flask equipped with mechanical stirring and a Dean-Stark trap coupled to a condenser. The flask was seated in an electric heating mantle. The heating mantle was controlled by a temperature controller with a thermocouple immersed into a glass well in contact with the flask contents. The stirred reaction flask contents were heated to 110° C. The mixture was stirred at 110° C. overnight. The next morning, a sample was taken for FTIR spectrophotometric analysis which showed a trace amount of ester absorbance at

1735 cm⁻¹. The reaction mixture was then allowed to cool to ambient temperature and 1500 milliliters of toluene was added. The toluene solution was then washed 4 times with 500 grams of aqueous 5% NaHCO₃. The washed toluene solution was dried over anhydrous magnesium sulfate and filtered. The filtrate was rotary evaporated for 3 hours at 60° C. and full vacuum plus 3 hours at 80° C. and full vacuum to remove the toluene. The final product was a semi-solid at ambient temperature. FTIR specrtrophotometric analysis and ¹H NMR analysis supported an amide polyol structure. The % OH for this material was 13.23.

### B. Synthesis of a Polyglycidyl Ether of a Reductively Hydroformylated Soybean Oil Methyl Ester Amide Polyol (3.3 Average Hydroxyl Functionality)

A portion (125 grams) of the reductively hydroformylated soybean oil methyl ester amide polyol (3.3 average hydroxyl functionality) from Part A above was added to a glass bottle along with dichloromethane (500 milliliters) and dissolved to form a solution. Sodium sulfate (granular, anhydrous) (40 grams) was added to the solution followed by gentle mixing for 16 hours on a mechanical shaker. The resultant product slurry was filtered through a bed of fresh sodium sulfate (granular, anhydrous) (40 grams) supported in a coarse fritted glass funnel with additional dichloromethane (75 milliliters) used to wash the product remaining in the contents of the filter into the filtrate. Rotary evaporation of the filtrate was completed to remove the dichloromethane. Toluene (200 milliliters) was added to the resultant product forming a slurry which was rotary evaporated using a maximum oil bath temperature of 120° C. to provide the dry reductively hydroformylated soybean oil methyl ester amide polyol (122 grams).

A one liter, three neck, glass, round bottom reactor was charged under nitrogen with epichlorohydrin (185.0 grams, 2.0 moles), sodium hydroxide (pellets, anhydrous, reagent grade, ≧98%) (44.0 grams, 1.10 moles), and sodium sulfate (granular. anhydrous) (85.2 grams, 0.60 mole). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). Pre-warmed dry reductively hydroformylated soybean oil methyl ester amide polyol (63.8 grams, 0.491 —OH equivalents) was added to a side arm vented addition funnel, and then attached to the reactor. Stirring commenced to give a 25° C. slurry of sodium hydroxide and sodium sulfate in epichlorohydrin. After stirring for 3 minutes, heating of the reactor commenced using a thermostatically controlled heating mantle. Once the stirred slurry equilibrated at 40° C., an initial aliquot of dry reductively hydroformylated soybean oil methyl ester amide polyol (4 milliliters) was added to the reactor. The reaction temperature was maintained at 40° C. during the addition of the aliquots unless otherwise noted. The aliquots were added, as follows:

| Cumulative time | | |
|---|---|---|
| from Addition | Amount of Aliquot | |
| of 1^{st} Aliquot (minutes) | (milliliters) | Observations |
| 17 | 10 | |
| 37 | 10 | Cloudy light yellow |
| | | colored slurry |
| 57 | 10 | |
| 77 | 10 | |
| 97 | 10 | |
| 117 | 10 | Cloudy light yellow |
| | | colored slurry |

The progress of the epoxidation reaction was monitored by HPLC analysis. After a cumulative 5.5 hours of reaction, additional epichlorohydrin (46.3 grams, 0.50 mole) was added to the thick, but still easily stirred, light tan colored slurry in the reactor. After a cumulative 23.7 hours of reaction, heating of the thin, tan colored slurry ceased followed by addition of MIBK (400 milliliters) and cooling of the reactor exterior to 25° C. with a fan. The MIBK slurry was vacuum filtered over a one inch pad of diatomaceous earth supported on a 600 milliliter coarse fritted glass funnel. Rotary evaporation of the filtrate using a maximum oil bath temperature of 70° C. provided 101.06 grams of opaque, white liquid. The solids remaining on top of the diatomaceous earth were collected into a bottle containing fresh MIBK (400 milliliters), then placed on the mechanical shaker for one hour. The MIBK slurry was then vacuum filtered through the diatomaceous earth pad followed by rotary evaporation of the additional filtrate to give a cumulative 98.5 grams of caramel colored, cloudy product (note: less weight was obtained due to more thorough rotary evaporation). The product was dissolved in toluene (150 milliliters), then vacuum filtered over a one-half inch pad of diatomaceous earth supported on a 600 milliliter coarse fritted glass funnel. Rotary evaporation of the filtrate using a maximum oil bath temperature of 70° C. provided 89.95 grams of transparent, yellow colored liquid.

Further rotary evaporation at 140° C. for one hour gave 86.4 grams of transparent, yellow colored liquid. GC analysis revealed that essentially all light boiling components, including residual epichlorohydrin and diglycidyl ether co-product had been removed. HPLC analysis revealed 100% conversion of the reductively hydroformylated soybean oil methyl ester amide polyol to products. Titration of a pair of aliquots of the product obtained demonstrated and average of 21.57% epoxide (199.48 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1645.4 cm⁻¹ for the polyglycidyl ether and 1622.1 cm⁻¹ for the polyol reactant,

(2) conversion of hydroxyl groups at 3362.9 cm⁻¹ in the polyol reactant with only a minor hydroxyl absorbance present in the polyglycidyl ether at 3456.2 cm⁻¹,

(3) appearance of a strong aliphatic ether C—O stretch at 1108.9 cm⁻¹ in the polyglycidyl ether, and

(4) appearance of epoxide ether C—O stretch at 1253.2 cm⁻¹, 910.6 cm⁻¹ and 848.6 cm⁻¹ in the polyglycidyl ether.

Both the polyol reactant and the polyglycidyl ether product possessed a very minor absorbance (1734.7 cm⁻¹ and 1732.5 cm⁻¹, respectively) which may be indicative of a slight amount of ester functionality.

The progress of the epoxidation reaction was monitored by HPLC analysis, with the results shown in following table. “None” for the cumulative reaction time designates the reductively hydroformylated soybean oil methyl ester amide polyol reactant used in the epoxidation reaction. “Final” designates the product recovered after completion of the work-up (rotary evaporation at 140° C.).

| | Cumulative Reaction | | | | |
|---|---|---|---|---|---|
| | Time After Completion of | | | | |
| Retention Time of | Soybean Oil Amide Polyol | | | | |
| Components Present at | (area percent) | | | | |
| ≧2 area % (min) | None | 63 min | 3.1 hr | 23.7 hr | Final |
| 2.29 | 6.15 | 2.02 | 0 | 0 | 0 |
| 2.95 | 41.07 | 23.97 | 0 | 0 | 0 |
| 3.01 | 0 | 0 | 0 | 2.59 | 0 |
| 3.28 | 0 | 0 | 1.91 | 3.05 | 0 |
| 3.37 | 0 | 18.55 | 3.34 | 0 | 0 |
| 4.02 | 0 | 0.93 | 16.52 | 0.99 | 0 |
| 4.59 | 0 | 0 | 1.98 | 0 | 0 |
| 5.05 | 3.55 | 1.79 | 0 | 0 | 0 |
| 5.21 | 2.93 | 1.52 | 0 | 0 | 0 |
| 5.35 | 0 | 0 | 2.65 | 0 | 0 |
| 5.42 | 12.98 | 7.71 | 0 | 0 | 0 |
| 5.47 | 0 | 0 | 0 | 7.20 | 7.28 |
| 5.55 | 0 | 0 | 6.46 | 0 | 0 |
| 5.69 | 12.06 | 6.37 | 4.43 | 0 | 0 |
| 6.44 | 0 | 5.32 | 0 | 0 | 0 |
| 6.51 | 0 | 0 | 2.83 | 0 | 0 |
| 6.71 | 0 | 4.81 | 0 | 0 | 0 |
| 6.79 | 0 | 0 | 2.37 | 0 | 0 |
| 7.16 | 0 | 0 | 0 | 14.13 | 15.85 |
| 7.25 | 0 | 0 | 3.58 | 15.82 | 17.94 |
| 7.40 | 0 | 0 | 2.69 | 0 | 0 |
| 7.60 | 0 | 0 | 9.67 | 0 | 0 |
| 7.76 | 0 | 0 | 0 | 1.79 | 1.93 |
| 7.86 | 0 | 0 | 9.03 | 0 | 0 |
| 8.96 | 11.89 | 9.14 | 0 | 0 | 0 |
| 9.66 | 0 | 0 | 0 | 3.14 | 3.55 |
| 9.83 | 0 | 0 | 0 | 2.39 | 2.66 |
| 10.06 | 0 | 0 | 0 | 11.05 | 12.46 |
| 10.37 | 0 | 0 | 0 | 10.52 | 11.70 |
| 10.56 | 0 | 0 | 5.21 | 0 | 0 |
| 12.11 | 0 | 0 | 0 | 15.28 | 17.82 |
| 12.40 | 0 | 0 | 10.49 | 0 | 0 |
| 13.16 | 6.06 | 4.98 | 0 | 0 | 0 |
| 15.13 | 0 | 2.86 | 5.37 | 0 | 0 |
| 17.90 | 0 | 0 | 0 | 7.62 | 8.82 |

### Example 4

### Preparation and Testing of Coatings Based on the Glycidyl Ether from Example 3 Part B

Reductively hydroformylated soybean oil methyl ester amide polyol glycidyl ether from Example 3 Part B (11.48 grams, 0.0575 equivalents), D.E.R.™ 331 epoxy resin, a bisphenol A diglycidyl ether available from The Dow Chemical Company (5.74 grams, 0.0305 equivalents), Ancamide™ 2353 curing agent by Air Products (10.03 grams, 0.0880 equivalents), and 3 drops of BYK™ 310 were combined in a glass bottle. These components were then stirred to obtain a homogeneous, transparent liquid. From this liquid, coatings were drawn down on 0.03 inch be 4 inch by 12 inch polished, cold roll steel panels using a #48 draw down bar from BYK Chemie USA. This formulation was also applied to 3 inch by 6 inch unpolished, coil coat white panels using a 10 mil draw down bar (also from BYK Chemie). The coatings were then cured for 7 days at ambient conditions and were then post cured for 24 hours at 140° F. in a forced air convection oven. After cure, the coating thicknesses were measured using a Fisherscope Film Thickness Meter. The coatings were then tested. The properties obtained from the testing of the coatings on the cold roll steel panels are given in Table 1 and those from the QUVA testing of the coatings on the coil coat white panels are given in Table 2.

### Example 5

### Preparation and Testing of Coatings Based on a Glycidyl Ether Prepared According to Example 3 Part B

Reductively hydroformylated soybean oil methyl ester amide polyol glycidyl ether prepared according to Example 3 Part B (21.11 grams, 0.1033 equivalents), Ancamide™ 2353 curing agent by Air Products (11.78 grams, 0.1033 equivalents), and 3 drops of BYK™ 310 were combined in a glass bottle. These components were then stirred to obtain a homogeneous, transparent liquid. From this liquid, coatings were drawn down on 0.03 inch be 4 inch by 12 inch polished, cold roll steel panels using a #48 draw down bar from BYK Chemie USA. This formulation was also applied to 3 inch by 6 inch unpolished, coil coat white panels using a 10 mil draw down bar (also from BYK Chemie). The coatings were then cured for 7 days at ambient conditions and were then post cured for 24 hours at 140° F. in a forced air convection oven. After cure, the coating thicknesses were measured using a Fisherscope Film Thickness Meter. The coatings were then tested. The properties obtained from the testing of the coatings on the cold roll steel panels are given in Table 1 and those from the QUVA testing of the coatings on the coil coat white panels are given in Table 2.

### Example 6

### Synthesis of a Polyglycidyl Ether of a Reductively Hydroformylated Soybean Oil Methyl Ester Amide Polyol (3.3 Average Hydroxyl Functionality) with Increased Washing

Preparation of an Amide Polyol from Diethanolamine and Reductively hydroformylated soybean oil methyl esters (3.3 hydroxyl functional) was completed using the method of Example 3 Part A with the single exception that the toluene solution was washed a total of 5 times with 500 milliliters of aqueous 5% NaHCO₃ followed by 2 times with 500 milliters of deionized water. The % OH for this material was 13.578. The polyglycidyl ether was synthesized using the method of Example 3 Part B with the exception that reductively hydroformylated soybean oil methyl ester amide polyol (3.3 functional) reactant was not predried over anhydrous sodium sulfate but was used directly. HPLC analysis revealed 100% conversion of the reductively hydroformylated soybean oil methyl ester amide polyol to products. Titration of a pair of aliquots of the product obtained demonstrated and average of 22.466% epoxide (191.54 EEW). FTIR spectrophotometric analysis of neat thin films of both the polyol reactant and the polyglycidyl ether thereof on a KCl plate demonstrated maintenance of the integrity of the amide linkage in the polyglycidyl ether (1645.4 cm⁻¹), conversion of hydroxyl groups in the polyol reactant with only a very minor hydroxyl absorbance present in the polyglycidyl ether (3447.6 cm⁻¹), appearance of a strong aliphatic ether C—O stretch in the polyglycidyl ether (1108.6 cm⁻¹), and appearance of epoxide ether C—O stretch in the polyglycidyl ether (1253.2 cm⁻¹, 910.6 cm⁻¹, and 848.4 cm⁻¹). Both the polyol reactant and the polyglycidyl ether product possessed a very minor absorbance which may be indicative of a slight amount of ester functionality.

The progress of the epoxidation reaction was monitored by HPLC analysis, with the results shown in following table. “None” for the cumulative reaction time designates the reductively hydroformylated soybean oil methyl ester amide polyol reactant used in the epoxidation reaction. “Final” designates the product recovered after completion of the work-up (rotary evaporation at 100° C.).

| | Cumulative Reaction Time After Completion of | | | | |
|---|---|---|---|---|---|
| Retention Time of | Soybean Oil Amide Polyol Addition | | | | |
| Components Present at | (area percent) | | | | |
| ≧2 area % (min) | None | 30 min | 2.6 hr | 18.2 hr | Final |
| 2.29 | 5.18 | 4.52 | 3.33 | 0 | 0 |
| 2.95 | 39.66 | 28.29 | 9.43 | 1.33 | 0 |
| 3.01 | 0 | 0 | 0 | 0 | 0 |
| 3.28 | 0 | 0 | 0 | 0 | 0 |
| 3.37 | 0 | 9.52 | 24.72 | 2.67 | 2.61 |
| 4.02 | 0 | 2.28 | 2.50 | 0 | 0 |
| 4.59 | 0 | 0 | 0 | 0 | 0 |
| 5.05 | 2.58 | 1.07 | 2.42 | 0 | 0 |
| 5.21 | 5.49 | 4.79 | 2.17 | 0 | 0 |
| 5.35 | 0 | 0 | 0 | 0 | 0 |
| 5.42 | 13.34 | 10.83 | 4.07 | 0 | 0 |
| 5.47 | 0 | 0 | 0 | 7.40 | 6.26 |
| 5.55 | 0 | 0 | 0 | 0 | 0 |
| 5.69 | 13.45 | 11.15 | 4.13 | 0 | 0 |
| 6.44 | 0 | 3.97 | 13.04 | 0 | 0 |
| 6.51 | 0 | 0 | 0 | 0 | 0 |
| 6.71 | 0 | 2.73 | 9.39 | 0 | 0 |
| 6.79 | 0 | 0 | 0 | 0 | 0 |
| 7.16 | 0 | 0 | 0 | 18.74 | 19.77 |
| 7.25 | 0 | 0 | 5.73 | 15.12 | 14.82 |
| 7.40 | 0 | 0 | 0 | 0 | 0 |
| 7.60 | 0 | 0 | 0 | 0 | 0 |
| 7.76 | 0 | 0 | 0 | 0 | 0 |
| 7.86 | 0 | 0 | 0 | 0 | 0 |
| 8.96 | 12.35 | 10.60 | 8.54 | 0 | 0 |
| 9.66 | 0 | 0 | 0 | 0 | 0 |
| 9.83 | 0 | 0 | 0 | 0 | 0 |
| 10.06 | 0 | 0 | 0 | 17.90 | 19.04 |
| 10.37 | 0 | 0 | 0 | 11.76 | 12.75 |
| 10.56 | 0 | 0 | 0 | 0 | 0 |
| 12.11 | 0 | 0 | 0 | 15.11 | 15.94 |
| 12.40 | 0 | 0 | 0 | 0 | 0 |
| 13.16 | 6.63 | 2.33 | 2.49 | 0 | 0 |
| 15.13 | 0 | 5.40 | 4.47 | 0 | 0 |
| 17.90 | 0 | 0 | 0 | 8.05 | 8.80 |

### Comparative Experiment A

### Preparation and Testing of Coatings Based on D.E.R.™ 331 Epoxy Resin (Control)

D.E.R.™ 331 epoxy resin, a bisphenol A diglycidyl ether available from The Dow Chemical Company (30.00 grams, 0.159 equivalents), Ancamide™ 2353 curing agent (18.14 grams, 0.159 equivalents, available from Air Products), and 3 drops of BYK were combined in a glass bottle. These components were then stirred to obtain a homogeneous, transparent liquid. From this liquid, coatings were drawn down on 0.03 inch by 4 inch by 12 inch polished, cold roll steel panels using a #48 draw down bar from BYK Chemie USA. This formulation was also applied to 3 inch by 6 inch unpolished, coil coat white panels using a 10 mil draw down bar (also from BYK Chemie). The coatings were then cured for 7 days at ambient conditions and were then post cured for 24 hours at 140° F. in a forced air convection oven. After cure, the coating thicknesses were measured using a Fisherscope Film Thickness Meter. The coatings were then tested. The properties obtained from the testing of the coatings on the cold roll steel panels are given in Table 1 and those from the QUVA testing of the coatings on the coil coat white panels are given in Table 2.

### Example 7

### A. Preparation of an Amide Polyol from Diethanolamine and Methyl 11-hydroxyundecanoate

Methyl 11-hydroxyundecanoate (158.4 grams; 0.7322 mole), diethanolamine (154.8 grams; 1.472 moles), 85% potassium hydroxide (2.60 grams; 0.039 mole), and 140 milliliters of toluene were placed in a 500 milliliter round bottom flask equipped with magnetic stirring and a water-cooled reflux condenser. The flask was seated in a sand bath in an electric heating mantle. The sand bath temperature was controlled by a temperature controller with a thermocouple immersed in the sand bath. The reaction flask was heated to 60° C. where all of the reactants dissolved in the toluene to yield a transparent solution. The mixture was stirred at 60° C. for 24 hours. At 24 hours, a sample was taken for FTIR which showed a trace amount of ester absorbance at 1729 cm⁻¹. More diethanolamine (10.2 grams) was added and the reaction mixture was stirred at 60° C. for another 18 hours. The reaction mixture was allowed to cool to room temperature and then rotary evaporated for 2 hours at 35° C. and 4 inches of Hg to remove the methanol. The resulting solid was stirred with 350 milliliters of aqueous, 2% NaCl for 3 hours and then vacuum filtered through a coarse glass-fritted Buchner funnel and rinsed with 100 milliliters of aqueous, 2% NaCl. The solid was mixed with 350 milliliters of fresh aqueous, 2% NaCl for 3 hours and then filtered through a coarse glass-fritted Buchner funnel. The solid was rinsed with 100 milliliters of aqueous, 2% NaCl two times followed by 100 milliliters of deionized water. The product was allowed to air dry in a vented hood for 3 days. The solid (180.7 grams) was mixed with 500 milliliters of toluene for two hours and then vacuum filtered through a coarse glass-fritted Buchner funnel. The solid was rinsed two times with 200 milliliters of toluene and allowed to air dry overnight. The material was then rotary evaporated to a constant weight. The final product, which was a white powder, weighed 158.9 grams (75.0% of theoretical). FTIR, ¹H NMR and ¹³C NMR analyses were conducted on the product. These analyses supported the amide triol structure given below.

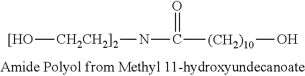

### B. Synthesis of a Polyglycidyl Ether of a Hydroxymethylundecanoate Amide Polyol

A one liter, three neck, glass, round bottom reactor was charged under nitrogen with epichlorohydrin (296.1 grams, 3.2 moles), sodium hydroxide (pellets, anhydrous, reagent grade, ≧98%) (35.8 grams. 0.9 moles), and sodium sulfate (granular, anhydrous) (79.5 grams, 0.56 mole). The reactor was additionally equipped with a condenser (maintained at 0° C.), a thermometer, a Claisen adaptor, an overhead nitrogen inlet (1 LPM N₂ used), a ground glass stopper, and a stirrer assembly (Teflon™ paddle, glass shaft, variable speed motor). Solid hydroxymethylundecanoate amide polyol (40.5 grams. 0.40 —OH equivalents) from Example 7 Part A above was weighed into a bottle and sealed. Stirring commenced to give a 24° C. slurry of sodium hydroxide and sodium sulfate in epichlorohydrin. After stirring for 2 minutes, heating of the reactor commenced using a thermostatically controlled heating mantle. Once the stirred slurry equilibrated at 40% an initial aliquot of the solid hydroxymethylundecanoate amide polyol (2.62 grams) was added to the reactor using a spatula. The reaction temperature was maintained at 40° C. during the addition of the aliquots unless otherwise noted. The aliquots were added, as follows:

| Cumulative time | | |
|---|---|---|
| from Addition | Amount of Aliquot | |
| of 1^{st} Aliquot (minutes) | (grams) | Observations |
| 20 | 3.81 | |
| 40 | 2.61 | |
| 60 | 3.10 | Light tan colored slurry |
| 80 | 3.53 | |
| 100 | 2.52 | |
| 120 | 4.17 | |
| 140 | 2.92 | |
| 160 | 3.31 | |
| 180 | 3.06 | |
| 200 | 3.29 | |
| 220 | 2.42 | |
| 240 | 3.14 | Off-white colored slurry |

The progress of the epoxidation reaction was monitored by HPLC analysis. After a cumulative 69.3 hours of reaction, heating of the thin, tan colored slurry ceased followed by addition of MIBK (400 milliliters) and cooling of the reactor exterior to 25° C. with a fan. The MIBK slurry equally divided into 4 polypropylene bottles which were sealed and centrifuged at 2000 RPM for 40 minutes. The top layer of transparent liquid was decanted through a one inch pad of diatomaceous earth supported on a 600 milliliter coarse fritted glass funnel using vacuum. The solids remaining in the bottles were equally diluted using fresh MIBK (400 milliliters), and then placed on the mechanical shaker for one hour, followed by centrifuging and decantation, as previously described. Additional MIBK (50 milliliters) used to wash the product remaining in the contents of the filter into the filtrate. Rotary evaporation of the filtrate finishing with a maximum oil bath temperature of 140° C. for one hour provided 54.19 grams of transparent, light amber liquid. GC analysis revealed that essentially all light boiling components, including residual epichlorohydrin and diglycidyl ether co-product had been removed. HPLC analysis revealed 100% conversion of the hydroxymethylundecanoate amide polyol to products. Titration of a pair of aliquots of the product obtained demonstrated and average of 26.10% epoxide (164.87 EEW). FTIR spectrophotometric analysis of neat thin films of both the polyol reactant and the polyglycidyl ether thereof on a KCl plate confirmed (note: the film of the polyol reactant was prepared by melting the solid on the KCl plate):

(1) maintenance of the integrity of the amide linkage in the polyglycidyl ether at 1644.1 cm⁻¹ for the polyglycidyl ether and 1604.7 cm⁻¹ for the polyol reactant,

(2) conversion of hydroxyl groups at 3427.8 cm⁻¹ and 3225.9 cm⁻¹ (shoulder also present) in the polyol reactant with only a minor hydroxyl absorbance present in the polyglycidyl ether at 3458.7 cm⁻¹,

(3) appearance of a strong aliphatic ether C—O stretch at 1110.1 cm⁻¹ in the polyglycidyl ether, and

(4) appearance of epoxide ether C—O stretch at 1253.8 cm⁻¹, 909.8 cm⁻¹ and 851.7 cm⁻¹ in the polyglycidyl ether.

Both the polyol reactant and the polyglycidyl ether product possessed a very minor absorbance (1733.8 cm⁻¹ and 1733.6 cm⁻¹, respectively) which may be indicative of a slight amount of ester functionality.

The progress of the epoxidation reaction was monitored by HPLC analysis, with the results shown in following table. “None” for the cumulative reaction time designates the methyl 11-hydroxyundecanoate amide polyol reactant used in the epoxidation reaction. “Final” designates the product recovered after completion of the work-up (rotary evaporation at 140° C.).

| Retention | | | | | | | |
|---|---|---|---|---|---|---|---|
| Time of | Cumulative Reaction Time | | | | | | |
| Components | After Completion of Methyl 11- | | | | | | |
| Present at | hydroxyundecanoate Amide Polyol | | | | | | |
| ≧2 area | (area percent) | | | | | | |
| % (min) | None | 1 hr | 17.1 hr | 24.8 hr | 45.1 hr | 69.3 hr | Final |
| 2.07 | 100 | 82.77 | 75.93 | 71.84 | 8.20 | 0 | 0 |
| 2.59 | 0 | 5.44 | 16.80 | 21.62 | 70.52 | 0 | 0 |
| 2.93 | 0 | 0 | 1.01 | 0.86 | 1.88 | 0 | 0 |
| 3.30 | 0 | 0 | 0 | 0 | 6.38 | 16.57 | 16.09 |
| 3.63 | 0 | 0 | 0 | 0 | 3.85 | 0 | 0 |
| 4.45 | 0 | 0 | 0 | 0 | 0.96 | 67.76 | 69.40 |
| 4.94 | 0 | 5.67 | 3.87 | 3.33 | 2.91 | 2.79 | 2.36 |
| 5.18 | 0 | 1.77 | 1.35 | 1.12 | 0.73 | 0 | 0 |
| 5.73 | 0 | 0 | 0 | 0 | 0 | 7.94 | 6.99 |
| 6.41 | 0 | 0 | 0 | 0 | 0 | 2.44 | 1.81 |

### Example 8

### Preparation and Testing of Coatings Based on the Glycidyl Ether from Example 7 Part B

Methyl 11-hydroxyundecanoate amide polyol glycidyl ether from Example 7 Part B (4.02 grams, 0.0244 equivalents), D.E.R.™ 331 epoxy resin, a bisphenol A diglycidyl ether available from The Dow Chemical Company (2.01 grams, 0.0106 equivalents), Ancamide™ 2353 curing agent by Air Products (4.00 grams, 0.0880 equivalents), and 3 drops of BYK™ 310 were combined in a glass bottle. These components were then stirred to obtain a homogeneous, transparent liquid. From this liquid, coatings were drawn down on 0.03 inch by

4 inch by 12 inch polished, cold roll steel panels using a #48 draw down bar from BYK Chemie USA. This formulation was also applied to 3 inch by 6 inch unpolished, coil coat white panels using a 10 mil draw down bar (also from BYK Chemie). The coatings were then cured for 5 days at ambient conditions and were then post cured for 24 hours at 140° F. in a forced air convection oven. After cure, the coating thicknesses were measured using a Fisherscope Film Thickness Meter. The coatings were then tested. The properties obtained from the testing of the coatings on the cold roll steel panels are given in Table 1 and those from the QUVA testing of the coatings on the coil coat white panels are given in Table 2.

### Example 9

### A. Preparation of an Amide Polyol from Diethanolamine and Reductively Hydroformylated Soybean Oil Methyl Esters (3.0 Average Hydroxyl Functionality)

Reductively hydroformylated soybean oil methyl esters (400.0 grams, 1.3 average hydroxyl functionality) and 511.7 grams of diethanolamine were weighed into a 2000 ml, 3-necked flask equipped with a heating mantle, thermocouple, mechanical stirrer, Dean-Stark trap with condenser, and a nitrogen head space purge tube. A solution of 0.93 grams of KOH in 10 milliliters of methanol was added to the flask. The flask was heated to, and maintained overnight at 110° C. The next morning the contents were allowed to cool prior to being dissolved in 1000 grams of toluene. The solution was washed three times with 1600 grams of a

2 weight % aqueous NaHCO₃ solution, dried with 80 grams of MgSO₄ and the product isolated by rotary evaporation of the solvent under reduced pressure at 60° C. Approximately 450 grams of product was recovered. ¹H NMR and FTIR analyses of the product were consistent with an amide triol structure.

### B. Synthesis of a Polyglycidyl Ether of a Reductively Hydroformylated Soybean Oil Methyl Ester Amide Polyol (3.0 Average Hydroxyl Functionality)

A portion (175 grams) of the reductively hydroformylated soybean oil methyl ester amide polyol (3.0 average hydroxyl functionality) from Part A above was added to a glass bottle along with dichloromethane (500 milliliters) and dissolved to form a solution. Sodium sulfate (granular, anhydrous) (50 grams) was added to the solution followed by gentle mixing for 16 hours on a mechanical shaker. The resultant product slurry was filtered through a bed of fresh sodium sulfate (granular, anhydrous) (40 grams) supported in a coarse fritted glass funnel with additional dichloromethane (75 milliliters) used to wash the product remaining in the contents of the filter into the filtrate. Rotary evaporation of the filtrate was completed to remove the dichloromethane. Toluene (200 milliliters) was added to the resultant product forming a slurry which was rotary evaporated using a maximum oil bath temperature of 120° C. to provide the dry reductively hydroformylated soybean oil methyl ester amide polyol (172.8 grams).

A one liter, three neck, glass, round bottom reactor was charged under nitrogen with epichlorohydrin (185.0 grams, 2.0 moles), sodium hydroxide (pellets, anhydrous, reagent grade, ≧98%) (44.0 grams, 1.10 moles), and sodium sulfate (granular, anhydrous) (85.2 grams, 0.60 mole). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). Pre-warmed dry reductively hydroformylated soybean oil methyl ester amide polyol (67.7 grams, 0.491 —OH equivalents) was added to a side arm vented addition funnel, and then attached to the reactor. Stirring commenced to give a 25° C. slurry of sodium hydroxide and sodium sulfate in epichlorohydrin. After stirring for 13 minutes, heating of the reactor commenced using a thermostatically controlled heating mantle. Once the stirred slurry equilibrated at 40° C., an initial aliquot of dry reductively hydroformylated soybean oil methyl ester amide polyol (8 milliliters) was added to the reactor. The reaction temperature was maintained at 40° C. during the addition of the aliquots unless otherwise noted. The aliquots were added, as follows:

| Cumulative time | | |
|---|---|---|
| from Addition | Amount of | |
| of 1^{st} Aliquot | Aliquot | |
| (minutes) | (milliliters) | Observations |
| 22 | 10 | |
| 42 | 10 | |
| 62 | 10 | |
| 82 | 10 | Light tan colored slurry |
| 102 | 10 | Light foaminess of surface of slurry, |
| | | exotherms to 42° C., cools |
| | | to 40° C. within several minutes |
| 122 | 10 | Slightly frothy, light tan colored slurry |

After a cumulative 23.2 hours of reaction, heating of the thin, light tan colored slurry ceased followed by addition of MIBK (400 milliliters) and cooling of the reactor exterior to 25° C. with a fan. The MIBK slurry was vacuum filtered over a one inch pad of diatomaceous earth supported on a 600 milliliter coarse fritted glass funnel. Rotary evaporation of the filtrate using a maximum oil bath temperature of 70° C. provided 95.07 grams of product. The solids remaining on top of the diatomaceous earth were collected into a bottle containing fresh MIBK (400 milliliters), and then placed on the mechanical shaker for one hour. The MIBK slurry was then vacuum filtered through the diatomaceous earth pad followed by rotary evaporation of the additional filtrate to give a cumulative 98.8 grams of product. Further rotary evaporation at 120° C. for one hour then 140° C. for one hour followed by filtration while hot over a one inch pad of diatomaceous earth supported on a 600 milliliter medium fritted glass funnel provided a slightly opaque, amber colored liquid. GC analysis revealed that essentially all light boiling components, including residual epichlorohydrin and diglycidyl ether co-product had been removed. HPLC analysis revealed 100% conversion of the reductively hydroformylated soybean oil methyl ester amide polyol to products. Titration of a pair of aliquots of the product obtained demonstrated and average of 20.74% epoxide (207.49 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1645.6 cm⁻¹ for the polyglycidyl ether and 1619.7 cm⁻¹ for the polyol reactant,

(2) conversion of hydroxyl groups at 3380.6 cm⁻¹ in the polyol reactant with only a trace of hydroxyl absorbance present in the polyglycidyl ether,

(3) appearance of a strong aliphatic ether C—O stretch at 1109.0 cm⁻¹ in the polyglycidyl ether, and

(4) appearance of epoxide ether C—O stretch at 1253.2 cm⁻¹, 910.5 cm⁻¹ and 848.5 cm⁻¹ in the polyglycidyl ether.

Both the polyol reactant and the polyglycidyl ether product possessed a very minor absorbance (1734.1 cm⁻¹ and 1733.6 cm⁻¹, respectively) which may be indicative of a slight amount of ester functionality.

The progress of the epoxidation reaction was monitored by HPLC analysis, with the results shown in following table. “None” for the cumulative reaction time designates the reductively hydroformylated soybean oil methyl ester amide polyol reactant used in the epoxidation reaction. “Final” designates the product recovered after completion of the work-up (rotary evaporation at 140° C.).

| Retention Time of | Cumulative Reaction Time After Completion of | | | | |
|---|---|---|---|---|---|
| Components Present at | Soybean Oil Amide Polyol (area percent) | | | | |
| ≧2 area % (min) | None | 70 min | 3.2 hr | 19.5 hr | Final |
| 2.29 | 2.64 | 0 | 0 | 0 | 0 |
| 2.96 | 26.12 | 0 | 0 | 0 | 0 |
| 3.02 | 0 | 0 | 0 | 2.12 | 2.81 |
| 3.27 | 0 | 1.98 | 1.17 | 1.70 | 1.64 |
| 3.36 | 0 | 2.62 | 0 | 0 | 0 |
| 4.00 | 0 | 8.85 | 3.12 | 0 | 0 |
| 4.98 | 3.16 | 1.79 | 0 | 0 | 0 |
| 5.07 | 8.70 | 0 | 0 | 0 | 0 |
| 5.31 | 0 | 2.44 | 4.68 | 0 | 0 |
| 5.44 | 13.94 | 0 | 0 | 0 | 0 |
| 5.50 | 0 | 4.12 | 7.66 | 3.38 | 3.07 |
| 5.64 | 0 | 2.61 | 3.66 | 0 | 0 |
| 5.71 | 13.95 | 0 | 0 | 0 | 0 |
| 6.07 | 0 | 3.17 | 0 | 0 | 0 |
| 6.45 | 0 | 3.00 | 0 | 0 | 0 |
| 6.72 | 0 | 2.73 | 0 | 0 | 0 |
| 7.18 | 0 | 8.33 | 12.93 | 11.65 | 11.26 |
| 7.29 | 0 | 0 | 0 | 8.48 | 8.65 |
| 7.53 | 0 | 8.74 | 8.77 | 1.30 | 1.40 |
| 7.78 | 0 | 8.88 | 8.48 | 1.09 | 1.07 |
| 9.01 | 12.91 | 0.73 | 0 | 0 | 0 |
| 9.67 | 0 | 1.38 | 4.80 | 10.50 | 10.74 |
| 10.11 | 0 | 1.19 | 5.28 | 11.82 | 12.08 |
| 10.40 | 0 | 5.08 | 5.50 | 12.16 | 12.33 |
| 12.20 | 0 | 8.77 | 13.20 | 14.01 | 14.09 |
| 13.24 | 18.58 | 0 | 0 | 0 | 0 |
| 15.15 | 0 | 4.91 | 0 | 0 | 0 |
| 18.02 | 0 | 12.86 | 19.33 | 20.19 | 20.49 |

### Example 10

### Synthesis of a Polyglycidyl Ether of a Distilled 9- and 10-Hydroxymethylstearate Amide Polyol

A two liter, three neck, glass, round bottom reactor was charged under nitrogen with epichlorohydrin (602.3 grams, 6.51 moles), sodium hydroxide (pellets, anhydrous, reagent grade, ≧98%) (107.5 grams. 2.69 moles), and sodium sulfate (granular, anhydrous) (208.3 grams, 1.47 moles). The reactor was additionally equipped with a condenser (maintained at −3° C.), a thermometer, a Claisen adaptor, an overhead nitrogen inlet (1 LPM N₂ used), a ground glass stopper, and a stirrer assembly (Teflon™ paddle, glass shaft, variable speed motor). Hydroxymethylstearate amide polyol (165.94 grams, 1.20 —OH equivalents) was added to a side arm vented addition funnel, and then attached to the reactor. The hydroxylmethylstearate used was a distilled product consisting predominately of a mixture of 9- and 10-hydroxylmethylstearates (88.7 area % by HPLC analysis with one isomer comprising 40.5 area % and the other isomer 48.2 area % and the balance as 9 minor components ranging from 0.60 to 3.8 area %.) The hydroxyl equivalent weight for this material was 138.288. Stirring commenced to give a 22° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C. dropwise addition of the hydroxymethylstearate commenced. The reaction temperature was maintained at 40° C. during the addition which was completed in 3.7 hours. The progress of the epoxidation reaction was monitored by HPLC analysis. The reaction slurry increased in viscosity 5.55 hours after completion of the addition but was still easily stirred. Additional epichlorohydrin (100 milliliters) was added at this time reducing viscosity. A cumulative 43.55 hours after the completion of the addition, heating of the thin, light tan colored slurry ceased followed by addition of MIBK (800 milliliters) and cooling of the reactor exterior to 25° C. with a fan. The MIBK slurry equally divided into 8 polypropylene bottles which were sealed and centrifuged at 3000 RPM for one hour. The top layer of transparent liquid was decanted through a pad of diatomaceous earth (one inch of Celite 545 bottom layer, ½ inch Celite Standard Super Cel middle layer, one inch of Celite 545 top layer) supported on a 600 milliliter medium fritted glass funnel using a side arm flask with vacuum. The slightly cloudy filtrate was recovered and passed through a second pad of diatomaceous earth (one inch of Celite 545 bottom layer, ½ inch Celite 577 middle layer, one inch of Celite 545 top layer) supported on a 600 milliliter medium fritted glass funnel using a side arm flask with vacuum. The filtrate from this second vacuum filtration was transparent. The solids remaining in the bottles were equally diluted using fresh MIBK (275 grams), and then placed on the mechanical shaker for 45 minutes, followed by centrifuging and decantation, as previously described. Additional MIBK (50 milliliters per filter) was used to wash the product remaining in the filter into the filtrate. Rotary evaporation of the filtrate finishing with a maximum oil bath temperature of 140° C. for one hour provided 113.80 grams of transparent, light amber liquid. GC analysis revealed that essentially all light boiling components, including residual epichlorohydrin and diglycidyl ether co-product had been removed. HPLC analysis revealed 100% conversion of the 9- and 10-hydroxymethylstearate amide polyol to products. Monoglycidyl ethers which were observed by HPLC analysis in the initial course of the epoxidation reaction were completely gone in the final epoxy resin product. Additionally, a pair of peaks observed by HPLC analysis comprising 7.36 area % and 5.18 area % were attributed to diglycidyl ethers. A second pair of peaks observed by HPLC analysis comprising 35.03 area % and 43.33 area % were attributed to triglycidyl ethers. The balance from the HPLC analysis of the epoxy resin product consisted of 8 minor components ranging from 0.80 area % to 1.48 area %. Titration of a pair of aliquots of the product obtained demonstrated and average of 20.95% epoxide (205.38 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1645.9 cm⁻¹ for the polyglycidyl ether and 1622.3 cm⁻¹ for the polyol reactant,

(2) conversion of hydroxyl groups at 3372.2 cm⁻¹ in the polyol reactant with only a very minor hydroxyl absorbance present in the polyglycidyl ether at 3454.3 cm⁻¹,

(3) appearance of a strong aliphatic ether C—O stretch at 1109.5 cm⁻¹ in the polyglycidyl ether, and

(4) appearance of epoxide ether C—O stretch at 1253.2 cm⁻¹, 910.6 cm⁻¹ and 848.4 cm⁻¹ in the polyglycidyl ether.

Both the polyol reactant and the polyglycidyl ether product possessed a very minor absorbance (1735.2 cm⁻¹ and 1733.5 cm⁻¹, respectively) which may be indicative of a slight amount of ester functionality.

The progress of the epoxidation reaction was monitored by HPLC analysis, with the results shown in following table. “None” for the cumulative reaction time designates the distilled grade of 9- and 10-hydroxymethylstearate amide triol reactant used in the epoxidation reaction. “Final” designates the product recovered after completion of the work-up (rotary evaporation at 140° C.).

| Retention Time of | Cumulative Reaction Time After | | | | | | | |
|---|---|---|---|---|---|---|---|---|
| Components | Completion of Distilled Grade of 9- and | | | | | | | |
| Present at | 10-Hydroxymethylstearate amide Triol Addition (area percent) | | | | | | | |
| ≧2 area % (min) | None | 68 min | 3.6 hr | 19.2 hr | 23.9 hr | 27.7 hr | 43.0 hr | Final |
| 1.51 | 0 | 0 | 1.61 | 1.94 | 1.89 | 1.95 | 2.03 | 1.48 |
| 1.57 | 0 | 2.12 | 0 | 0 | 0 | 0 | 0 | 0 |
| 1.91 | 3.81 | 0 | 0 | 0 | 0 | 0 | 0 | 0 |
| 2.12 | 0 | 0 | 0.92 | 2.52 | 2.80 | 3.14 | 3.68 | 0.93 |
| 2.62 | 0 | 2.25 | 0.89 | 0 | 0 | 0 | 0 | 0 |
| 3.26 | 40.48 | 0 | 0 | 0 | 0 | 0 | 0 | 0 |
| 3.36 | 48.20 | 0 | 0 | 0 | 0 | 0 | 0 | 0 |
| 3.98 | 0 | 18.13 | 0 | 0 | 0 | 0 | 0 | 0 |
| 4.08 | 0 | 19.13 | 0 | 0 | 0 | 0 | 0 | 0 |
| 4.87 | 0 | 17.68 | 26.33 | 13.81 | 11.53 | 10.49 | 7.41 | 7.36 |
| 4.96 | 0 | 20.56 | 30.07 | 13.89 | 10.80 | 9.79 | 6.19 | 5.18 |
| 5.25 | 0 | 0 | 0.84 | 1.69 | 1.89 | 2.08 | 2.49 | 0.83 |
| 5.45 | 0 | 2.19 | 0 | 0 | 0 | 0 | 0 | 0 |
| 5.63 | 0 | 0 | 0 | 0 | 0 | 0 | 0 | 0 |
| 6.41 | 0 | 0 | 11.17 | 27.59 | 29.38 | 29.42 | 32.09 | 35.03 |
| 6.46 | 0 | 3.34 | 14.34 | 35.34 | 37.43 | 36.96 | 39.73 | 43.33 |
| 6.99 | 0 | 0 | 1.04 | 1.72 | 2.09 | 1.87 | 2.12 | 0.80 |
| 7.30 | 0 | 1.13 | 0 | 0 | 0 | 0 | 0 | 0 |
| 8.48 | 0 | 0 | 0 | 0 | 0 | 0 | 0 | 0 |
| 8.62 | 0 | 0 | 0 | 0 | 0 | 2.34 | 1.47 | 1.39 |
| 8.81 | 0 | 0 | 0 | 0 | 0 | 0 | 0 | 0 |
| 9.01 | 0 | 0 | 0 | 0 | 0 | 0 | 0 | 0 |

### Example 11

### Synthesis of a Polyglycidyl Ether of a Recrystallized 12-Hydroxymethylstearate Amide Polyol

A two liter, three neck, glass, round bottom reactor was charged under nitrogen with epichlorohydrin (351.0 grams, 3.79 moles), sodium hydroxide (pellets, anhydrous, reagent grade, ≧98%) (60.7 grams. 1.52 moles), and sodium sulfate (granular, anhydrous) (150.9 grams, 1.06 moles). The reactor was additionally equipped with a condenser (maintained at 0° C.), a thermometer, a Claisen adaptor, an overhead nitrogen inlet (1 LPM N₂ used), a ground glass stopper, and a stirrer assembly (Teflon™ paddle, glass shaft, variable speed motor). 12-Hydroxymethylstearate amide polyol (95.00 grams, 0.759 —OH equivalents) was added to a side arm vented addition funnel, and then attached to the reactor. The 12-hydroxylmethylstearate used was a recrystallized product from hydrogenated methyl ricinoloate. The % —OH for the 12-hydroxylmethylstearate amide polyol was 13.58. Stirring commenced to give a 23° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C. addition of the

12-hydroxymethylstearate commenced in 20 milliliter aliquots. The reaction temperature was maintained at 40° C. during the addition which was completed in 1.33 hours. The progress of the epoxidation reaction was monitored by HPLC analysis. A cumulative 27.13 hours after the completion of the addition, heating of the thin, off white slurry ceased followed by addition of MIBK (400 milliliters) and cooling of the reactor exterior to 25° C. with a fan. The MIBK slurry equally divided into 4 polypropylene bottles which were sealed and centrifuged at 3000 RPM for one hour. The top layer of transparent liquid was decanted through a pad of diatomaceous earth (one inch of Celite 545 bottom layer, ½ inch Celite 577 middle layer, one inch of Celite 545 top layer) supported on a 600 milliliter medium fritted glass funnel using a side arm flask with vacuum. The filtrate from this vacuum filtration was a transparent, light yellow colored solution. The solids remaining in the bottles were equally diluted using fresh MIBK to give a total weight of 280 grams per bottle, and then placed on the mechanical shaker for 45 minutes, followed by centrifuging and decantation, as previously described. Additional MIBK (50 milliliters) was used to wash the product remaining in the filter into the filtrate. Rotary evaporation of the filtrate finishing with a maximum oil bath temperature of 100° C. for one hour provided 145.61 grams of transparent, light yellow colored liquid. The liquid was dissolved into toluene (200 milliliters) containing anhydrous sodium sulfate (2.0 grams), sealed and magnetically stirred 12 hours. Vacuum filtration through a pad of diatomaceous earth and silica gel (½ inch of Celite 545 bottom layer, ¼ inch silica gel middle layer, ½ inch of Celite 545 top layer) supported on a 600 milliliter medium fritted glass funnel using a side arm flask provided a transparent, yellow colored filtrate. Rotary evaporation of the filtrate finishing with a maximum oil bath temperature of 100° C. for two hours provided 130.44 grams of transparent, amber colored liquid. GC analysis revealed that essentially all light boiling components, including residual epichlorohydrin and diglycidyl ether co-product had been removed. HPLC analysis revealed 100% conversion of the 12-hydroxymethylstearate amide polyol to products. Titration of a pair of aliquots of the product obtained demonstrated and average of 21.80% epoxide (197.39 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1642.1 cm⁻¹ for the polyglycidyl ether and 1618.9 cm⁻¹ for the polyol reactant,

(2) conversion of hydroxyl groups at 3340.9 cm⁻¹ in the polyol reactant with only minor hydroxyl absorbance present in the polyglycidyl ether at 3450.3 cm⁻¹,

(3) appearance of a strong aliphatic ether C—O stretch at 1110.4 cm⁻¹ in the polyglycidyl ether, and

(4) appearance of epoxide ether C—O stretch at 1253.5 cm⁻¹, 910.8 cm⁻¹ and 850.6 cm⁻¹ in the polyglycidyl ether.

Both the polyol reactant and the polyglycidyl ether product possessed a very minor absorbance (1737.3 cm⁻¹ [shoulder also present] and 1739.1 cm⁻¹ and 1708.7 cm⁻¹, respectively) which may be indicative of a slight amount of ester functionality.

The progress of the epoxidation reaction was monitored by HPLC analysis, with the results shown in following table. “None” for the cumulative reaction time designates the 12-hydroxymethylstearate amide polyol reactant used in the epoxidation reaction. “Final” designates the product recovered after completion of the work-up (rotary evaporation at 100° C.).

| | |
|---|---|
| | Cumulative Reaction Time |
| | After Completion of 12- |
| | Hydroxylmethylstearate |
| Retention Time of | Amide Polyol Addition |
| Components Present at | (area percent) |

| ≧2 area % (min) | None | Final |
|---|---|---|
| 1.54 | 3.65 | 0 |
| 3.47 | 18.29 | 0 |
| 4.10 | 0 | 2.07 |
| 4.30 | 59.14 | 0 |
| 4.32 | 0 | 53.50 |
| 5.34 | 0 | 2.79 |
| 5.65 | 0 | 27.20 |
| 7.28 | 2.86 | 5.85 |
| 7.43 | 3.61 | 0 |
| 8.08 | 4.29 | 0 |
| 8.11 | 0 | 4.89 |
| 8.55 | 0 | 2.31 |
| 9.79 | 0 | 4.42 |

### Example 12

### Synthesis of a Polyglycidyl Ether of a 12-Hydroxymethylstearate Amide Polyol

A one liter, three neck, glass, round bottom reactor was charged under nitrogen with epichlorohydrin (155.9 grams, 1.68 moles), sodium hydroxide (pellets, anhydrous, reagent grade, ≧98%) (26.9 grams. 0.674 mole), and sodium sulfate (granular, anhydrous) (67.0 grams, 0.47 mole). The reactor was additionally equipped with a condenser (maintained at 0° C.), a thermometer, a Claisen adaptor, an overhead nitrogen inlet (1 LPM N₂ used), a ground glass stopper, and a stirrer assembly (Teflon™ paddle, glass shaft, variable speed motor). 12-Hydroxymethylstearate (hydrogenated castor oil) amide polyol (46.08 grams, 0.337 —OH equivalent) was added to a side arm vented addition funnel, and then attached to the reactor. The 12-hydroxymethylstearate used to prepare the amide polyol was a commercial product, Paracin I. The % —OH for the 12-hydroxymethylstearate; amide polyol was 12.43. Stirring commenced to give a 22° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C. addition of the hydrogenated castor oil amide polyol commenced in 10 milliliter aliquots. The reaction temperature was maintained at 40° C. during the addition which was completed in 62 minutes. The progress of the epoxidation reaction was monitored by HPLC analysis. The reaction slurry increased in viscosity 19.3 hours after completion of the addition but was still easily stirred. Additional epichlorohydrin (100 milliliters) was added at this time reducing viscosity. A cumulative 19.5 hours after the completion of the addition, heating of the thin, off white slurry ceased followed by addition of MIBK (400 milliliters) and cooling of the reactor exterior to 25° C. with a fan. The MIBK slurry equally divided into 4 polypropylene bottles which were sealed and centrifuged at 3000 RPM for one hour. The top layer of transparent liquid was decanted through a pad of diatomaceous earth (one inch of Celite 545 bottom layer, one inch Celite 577 middle layer, ¾ inch of Celite 545 top layer) supported on a 600 milliliter medium fritted glass funnel using a side arm flask with vacuum. The filtrate from this vacuum filtration was a transparent, light yellow colored solution. The solids remaining in the bottles were equally diluted using fresh MIBK to give a total weight of 270 grams per bottle, and then placed on the mechanical shaker for one hour, followed by centrifuging and decantation, as previously described. Additional MIBK (50 milliliters) was used to wash the product remaining in the filter into the filtrate. Rotary evaporation of the filtrate finishing with a maximum oil bath temperature of 72° C. for one hour provided 65.40 grams of transparent, light yellow colored liquid. The liquid was dissolved into toluene (100 milliliters) containing anhydrous sodium sulfate (2.0 grams), sealed and magnetically stirred 4 hours. Vacuum filtration through a pad of diatomaceous earth and silica gel (½ inch of Celite 545 bottom layer, ¼ inch silica gel middle layer, ½ inch of Celite 545 top layer) supported on a 600 milliliter medium fritted glass funnel using a side arm flask provided a transparent, light yellow colored filtrate. Rotary evaporation of the filtrate finishing with a maximum oil bath temperature of 110° C. for two hours provided 55.87 grams of transparent, light amber colored liquid. GC analysis revealed that essentially all light boiling components, including residual epichlorohydrin and diglycidyl ether co-product had been removed. HPLC analysis revealed 100% conversion of the 12-hydroxymethylstearate amide polyol to products. Titration of a pair of aliquots of the product obtained demonstrated and average of 21.06% epoxide (204.32 EEW). FTIR spectrophotometric analysis of neat thin films of both the polyol reactant and the polyglycidyl ether thereof on a KCl plate demonstrated maintenance of the integrity of the amide linkage in the polyglycidyl ether (1645.2 cm⁻¹, strong) conversion of hydroxyl groups in the polyol reactant with only a minor hydroxyl absorbance present in the polyglycidyl ether (3446.8 cm⁻¹, weak) appearance of a strong aliphatic ether C—O stretch in the polyglycidyl ether (1110.4 cm⁻¹), and appearance of epoxide ether C—O stretch in the polyglycidyl ether (1253.4 cm⁻¹, 910.4 cm⁻¹ and 849.8 cm⁻¹. medium). Both the polyol reactant and the polyglycidyl ether product possessed a very minor absorbance which may be indicative of a slight amount of ester functionality (1733.8 cm⁻¹, weak, for the polyglycidyl ether).

The progress of the epoxidation reaction was monitored by HPLC analysis, with the results shown in following table. “None” for the cumulative reaction time designates the hydrogenated castor oil amide polyol reactant used in the epoxidation reaction. “Final” designates the product recovered after completion of the work-up (rotary evaporation at 110° C.).

| Retention Time of | Cumulative Reaction Time After Completion | | | | |
|---|---|---|---|---|---|
| Components | of 12-Hydroxymethylstearate Amide | | | | |
| Present at | Polyol Addition (area percent) | | | | |
| ≧3 area % (min) | None | 62 min | 3.4 hr | 19.5 hr | Final |
| 1.34 | 2.69 | 1.13 | 0 | 0 | 0 |
| 1.57 | 0 | 0 | 3.15 | 2.10 | 0 |
| 2.83 | 85.07 | 32.05 | 0 | 0 | 0 |
| 3.48 | 0 | 50.03 | 5.32 | 0 | 0 |
| 4.32 | 0 | 2.10 | 71.93 | 68.82 | 68.82 |
| 5.64 | 0 | 0 | 1.77 | 15.07 | 15.72 |
| 6.31 | 9.30 | 4.68 | 0 | 0 | 0 |
| 7.30 | 0 | 5.85 | 3.07 | 0 | 0 |
| 7.42 | 0 | 0 | 2.38 | 0 | 0 |
| 8.07 | 0 | 0 | 3.98 | 5.02 | 4.68 |
| 8.50 | 0 | 0 | 8.39 | 9.00 | 9.55 |

### Example 13

### Large Scale Synthesis and Aqueous Processing of a Polyglycidyl Ether of a Reductively Hydroformylated Soybean Oil Methyl Ester Amide Polyol (3.3 Average Hydroxyl Functionality)

A 5 liter, three neck, glass, round bottom reactor was charged under nitrogen with epichlorohydrin (2780.1 grams, 30.03 moles), sodium hydroxide (pellets, anhydrous, reagent grade, ≧98%) (480.5 grams, 12.01 moles), and sodium sulfate (granular, anhydrous) (1194.4 grams, 8.41 moles). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). A pre-warmed reductively hydroformylated soybean oil methyl ester amide polyol (771.0 grams, 6.007 —OH equivalents) with a 3.3 average hydroxyl functionality and 13.25% hydroxyl by titration was added to a side arm vented addition funnel, and then attached to the reactor. Stirring commenced to give a 22° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C., an initial aliquot of reductively hydroformylated soybean oil methyl ester amide polyol (40 milliliters) was added to the reactor. The reaction temperature was maintained at 40° C. during the addition of the aliquots unless otherwise noted. The dropwise addition of a 40 milliliter aliquot required 5 minutes. The dropwise addition of a 50 milliliter aliquot required 6 minutes. The aliquots were added, as follows:

| Cumulative time from Addition | Amount of Aliquot | |
|---|---|---|
| of 1^{st} Aliquot (minutes) | (milliliters) | Observations |
| 20 | 40 | Cloudy off-white |
| | | slurry, thin |
| 40 | 40 | |
| 60 | 40 | |
| 80 | 40 | |
| 100 | 40 | |
| 120 | 40 | Cloudy off-white |
| | | slurry, thin |
| 140 | 40 | |
| 160 | 40 | |
| 180 | 40 | |
| 200 | 40 | |
| 220 | 40 | Cloudy off-white |
| | | slurry, thin |
| 240 | 40 | |
| 260 | 40 | |
| 280 | 40 | |
| 300 | 40 | |
| 320 | 50 | |
| 340 | 50 | |
| 360 | 50 | Off-white |
| | | slurry, thin |

The progress of the epoxidation reaction was monitored by HPLC analysis. Twenty minutes after completion of addition of the reductively hydroformylated soybean oil methyl ester amide polyol, HPLC analysis revealed that 51% conversion of said polyol had occurred. A cumulative 15.1 hours after completion of addition of the reductively hydroformylated soybean oil methyl ester amide polyol, HPLC analysis revealed full conversion of the polyol. A cumulative 18.7 hours after completion of addition of the polyol, heating of the thin, light tan colored slurry ceased followed by addition of MIBK (1.2 liters) and cooling of the reactor exterior to 25° C. with a fan. The MIBK slurry was equally divided into a set of polypropylene bottles which were sealed and centrifuged at 2000 RPM for 30 minutes. The top layer of transparent liquid was decanted through a one inch pad of diatomaceous earth (Celite™ 545) supported on a 600 milliliter coarse fritted glass funnel using a side arm vacuum flask. The solids remaining in the bottles along with any solids remaining on top of the diatomaceous earth were equally diluted using fresh MIBK (1.2 liters total volume used), and then placed on the mechanical shaker for one hour, followed by centrifuging and decantation, as previously described. Additional MIBK (100 milliliters) was used to wash the product remaining in the contents of the filter into the filtrate. The combined filtrates were added to a 10 liter separatory funnel and vigorously washed with a 1% by weight solution of sodium dihydrogen phosphate monohydrate in DI water (1 liter). The transparent, light yellow colored organic layer recovered from the separatory funnel was added back into the separatory funnel and washed twice with DI water (1 liter per wash). The transparent, light yellow colored organic layer was recovered and rotary evaporated using a maximum oil bath temperature of 90° C. to a vacuum of 0.34 mm Hg to provide 1042.8 grams of transparent yellow colored liquid. HPLC analysis revealed 100% conversion of the reductively hydroformylated soybean oil methyl ester amide polyol to the epoxy resin product with the same distribution previously observed at the end of the epoxidation reaction (before work-up). Titration of a pair of aliquots of the product demonstrated an average of 20.74% epoxide (207.50 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1644.6 cm⁻¹ and 1621.5 cm⁻¹ for the polyol reactant,

(2) conversion of hydroxyl groups at 3362.0 cm⁻¹ in the polyol reactant with only a minor hydroxyl absorbance present in the polyglycidyl ether at 3460.9 cm⁻¹,

(3) appearance of a strong aliphatic ether C—O stretch at 1108.8 cm⁻¹ in the polyglycidyl ether, and

(4) appearance of epoxide ether C—O stretch at 1253.2 cm⁻¹, 910.4 cm⁻¹ and 848.6 cm⁻¹ in the polyglycidyl ether.

Both the polyol reactant and the polyglycidyl ether product possessed a minor absorbance (1734.7 cm⁻¹ and 1733.1 cm⁻¹, respectively) which may be indicative of a slight amount of ester functionality.

The progress of the epoxidation reaction was monitored by HPLC analysis, with the results shown in following table. “None” for the cumulative reaction time designates the reductively hydroformylated soybean oil methyl ester amide polyol reactant used in the epoxidation reaction.

| | |
|---|---|
| | Cumulative Reaction |
| | Time After |
| | Completion of Soybean |
| Retention Time of | Oil Amide Polyol Addition |
| Components Present at | (area percent) |

| ≧2 area % (min) | None | 20 min | 15.1 hr | 18.7 hr |
|---|---|---|---|---|
| 1.24 | 2.31 | 2.12 | 0.91 | 0.90 |
| 1.52 | 5.63 | 1.70 | 0 | 0 |
| 1.61 | 0 | 1.96 | 0 | 0 |
| 1.92 | 41.41 | 16.64 | 0 | 0 |
| 2.12 | 0 | 0 | 2.93 | 1.33 |
| 2.20 | 0 | 19.50 | 0 | 0 |
| 2.63 | 0 | 2.10 | 1.49 | 1.25 |
| 2.88 | 0 | 1.92 | 0 | 0 |
| 3.27 | 18.21 | 9.91 | 0 | 0 |
| 3.36 | 12.85 | 6.19 | 0 | 0 |
| 3.51 | 0 | 0 | 3.65 | 3.99 |
| 3.60 | 0 | 0 | 7.15 | 6.62 |
| 3.69 | 0 | 0 | 3.45 | 3.63 |
| 3.99 | 0 | 9.48 | 0 | 0 |
| 4.09 | 0 | 6.66 | 0 | 0 |
| 4.85 | 0 | 0 | 31.88 | 30.99 |
| 4.94 | 10.97 | 7.41 | 0 | 0 |
| 6.34 | 5.10 | 2.93 | 0 | 0 |
| 6.42 | 0 | 0 | 14.71 | 15.00 |
| 6.48 | 0 | 0 | 9.14 | 9.11 |
| 6.99 | 0 | 0 | 14.76 | 13.93 |
| 7.33 | 0 | 2.93 | 0 | 0 |
| 8.55 | 0 | 0 | 7.34 | 6.49 |

### Example 14

### A. Synthesis of a Phthalic Acid Ester of a Reductively Hydroformylated Soybean Oil Methyl Ester Amide Polyol (3.3 Average Hydroxyl Functionality)

A reductively hydroformylated soybean oil methyl ester amide polyol (3.3 average hydroxyl functionality, 12.34% —OH) prepared according to Example 3 Part A (50.29 grams, 0.3649 —OH equivalent) and phthalic anhydride (54.06 grams, 0.365 carboxylic acid anhydride equivalent) were placed in a 100 milliliter round bottom flask equipped with mechanical stirring and a nitrogen pad. The flask was seated in an electric heating mantle. The heating mantle was controlled by a temperature controller with a thermocouple immersed in the flask contents. The flask contents were heated to 135° C. and maintained therein for 3 hours with stirring. Titration of an aliquot of the product for % —COOH gave 15.38 versus a theoretical % —COOH of 15.75.

### B. Synthesis of a Polyglycidyl Ester of a Phthalic Acid Ester of a Reductively Hydroformylated Soybean Oil Methyl Ester Amide Polyol

Drying

The phthalic acid ester of a reductively hydroformylated soybean oil methyl ester amide polyol from A. above was added to a glass bottle along with ethyl acetate (300 milliliters) and dissolved to form a solution. Sodium sulfate (granular, anhydrous) (30 grams) was added to the solution followed by gentle mixing for 16 hours on a mechanical shaker. The resultant product slurry was filtered through a bed of fresh sodium sulfate (granular, anhydrous) (30 grams) supported in a medium fritted glass funnel with additional ethyl acetate (50 milliliters) used to wash the product remaining in the contents of the filter into the filtrate. Rotary evaporation of the filtrate was completed to remove the ethyl acetate. Rotary evaporation using a maximum oil bath temperature of 120° C. provided the dry phthalic acid ester of a reductively hydroformylated soybean oil methyl ester amide polyol.

### Quaternary Ammonium Halide Catalyzed Coupling Reaction

A one liter, three neck, glass, round bottom reactor was charged under nitrogen with epichlorohydrin (138.8.0 grams, 1.5 moles), sodium sulfate (granular, anhydrous) (14.2 grams, 0.10 mole), dry, solid phthalic acid ester of a reductively hydroformylated soybean oil methyl ester amide polyol (29.27 grams, 0.01 —COOH equivalent), and tetra-butylammonium bromide catalyst (0.293 gram, 1% by weight of the phthalic acid ester). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). Stirring of the 23° C. slurry commenced concurrent with heating initiated using a thermostatically controlled heating mantle. Once the stirred slurry reached 33° C., a light yellow colored solution formed containing suspended sodium sulfate. Heating continued to 80° C. and this temperature was maintained for the next 16 hours followed by heating to 100° C. over a 33 minute period and holding at this temperature for the next 7.1 hours. FTIR spectrophotometric analysis of a neat thin film of the tris(chlorohydrin ester) with epichlorohydrin removed by devolatilization on a KCl plate confirmed:

(1) maintenance of the integrity of the amide linkage as shown by strong amide carbonyl absorbance at 1644.5 cm⁻¹,

(2) minor hydroxyl group absorbance at 3436.1 cm⁻¹ (shoulder present),

(3) very strong ester carbonyl absorbance at 1728.8 cm⁻¹, and

(4) no carbonyl absorbance attributable to carboxylic acid.

Dehydrochlorination

The slurry containing the tris(chlorohydrin ester) was cooled to 24° C. and charged under nitrogen with additional epichlorohydrin (92.5 grams, 1.0 mole), sodium hydroxide (pellets, anhydrous, reagent grade, ≧98%) (4.52 grams, 0.113 mole), and sodium sulfate (granular, anhydrous) (17.76 grams, 0.125 mole). Stirring and heating of the reactor commenced. The reaction temperature was maintained at 40° C. The progress of the epoxidation reaction was monitored by HPLC analysis. After 16 hours of reaction, heating of the opaque light orange colored slurry ceased followed by addition of MIBK (400 milliliters) and cooling of the reactor exterior to 25° C. with a fan. The MIBK slurry was vacuum filtered over a one inch pad of diatomaceous earth supported on a 600 milliliter coarse fritted glass funnel. The contents of the filter were washed with additional MIBK (100 milliliters). Rotary evaporation of the filtrate using a maximum oil bath temperature of 70° C. provided 43.03 grams of caramel colored, cloudy, viscous, liquid. Further rotary evaporation at 140° C. for one hour gave 37.06 grams. GC analysis revealed that essentially all light boiling components, including residual epichlorohydrin and diglycidyl ether co-product had been removed. HPLC analysis revealed two major clusters of components in the polyglycidyl ester product: (a) 18 components with retention times between 1.22 and 3.83 collectively comprising 53.24 area % and (b) 13 components with retention times between 6.05 and 10.35 collectively comprising 46.76 area %. Titration of a pair of aliquots of the product obtained demonstrated and average of 5.66% epoxide (760.4 EEW). FTIR spectrophotometric analysis of a neat thin film of the polyglycidyl ester on a KCl plate confirmed:

(1) maintenance of the integrity of the amide linkage as shown by strong amide carbonyl absorbance at 1644.9 cm⁻¹,

(2) minor hydroxyl group absorbance at 3435.5 cm⁻¹ (shoulder present),

(3) very strong ester carbonyl absorbance at 1728.4 cm⁻¹,

(4) no carbonyl absorbance attributable to carboxylic acid, and

(5) appearance of epoxide ether C—O stretch at 909.6 cm⁻¹ and 843.7 cm⁻¹.

For the coupling reaction product, in the FTIR spectrophotometric analysis the following ratios were obtained against the peak at 2927 cm⁻¹: amide carbonyl=0.505, ester carbonyl=1.557, —OH=0.105. For the polyglycidyl ester product, in the FTIR spectrophotometric analysis the following ratios were obtained against the peak at 2927 cm⁻¹: amide carbonyl=0.527, ester carbonyl=1.120, —OH=0.182. Considering these ratios, the lower than theoretical EEW for the polyglycidyl ester (1) does not involve any reaction of amide linkages and (2) is related to the higher —OH ratio which may be indicative of ring opening reaction of epoxide groups in the polyglycidyl ester generating secondary hydroxyl groups. Ring opening reaction of epoxide groups may result from reactions promoted by the presence of the residual coupling catalyst.

### Example 15

### Synthesis of a Diglycidyl Ether of a Commercial Grade Lauric Acid Diethanolamide

A one liter, three neck, glass, round bottom reactor was charged under nitrogen with epichlorohydrin (277.7 grams, 3.0 moles), sodium hydroxide (pellets, anhydrous, reagent grade, ≧98%) (48.0 grams, 1.20 moles), and sodium sulfate (granular.

anhydrous) (119.3 grams, 0.84 mole). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). Lauric acid diethanolamide (86.23 grams, 0.60 —OH equivalent) was added to a side arm vented addition funnel, and then attached to the reactor. The lauric acid diethanolamide used was a commercial grade product sold by Rhodia, Inc. under the product name Alkamide LE. Lauric acid diethanolamide content was >94% with residual diethanolamine<6%. The product was used as received without modification. Stirring commenced to give a 20° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C., an initial aliquot of lauric acid diethanolamide (10 milliliters) was added to the reactor over a 3 minute period. The reaction temperature was maintained at 40° C. during the addition of the aliquots. The aliquots were added at 20 minute intervals with the entire cumulative addition time comprising 160 minutes. At the end of the addition, the product in the reactor was an easily stirred, slightly frothy, white slurry.

The progress of the epoxidation reaction was monitored by HPLC analysis. HPLC analysis 1.5 hours after completion of addition of the lauric acid diethanolamide addition revealed that full conversion of said diol had occurred. After a cumulative 20.33 hours of reaction, heating of the thin, light tan colored slurry ceased followed by addition of MIBK (300 milliliters). The MIBK slurry was equally divided into a set of 4 polypropylene bottles which were sealed and centrifuged at 2000 RPM for one hour. The top layer of transparent liquid was decanted through a pad of diatomaceous earth (½ inch of Celite™ 545 bottom layer, ½ inch Celite™ 577 middle layer, ½ inch of Celite™ 545 top layer) supported on a 600 milliliter medium of diatomaceous earth (Celite™ 545) supported on a 600 milliliter medium fritted glass funnel using a side arm vacuum flask. The solids remaining in the bottles along with any solids remaining on top of the diatomaceous earth were diluted using fresh MIBK to a total weight of 250 grams and then placed on the mechanical shaker for one hour, followed by centrifuging and decantation, as previously described. A second extraction of the solids was completed using the aforementioned method. Additional MIBK (50 milliliters) was used to wash the product remaining in the contents of the filter into the filtrate. Rotary evaporation of the filtrate using a maximum oil bath temperature of 75° C. removed the bulk of the volatiles. Further rotary evaporation at 110° C. to a vacuum of 0.26 mm Hg provided 121.56 grams of transparent, light amber colored liquid. GC analysis revealed that essentially all light boiling components, including residual epichlorohydrin and diglycidyl ether co-product had been removed. HPLC analysis revealed 100% conversion of the lauric acid diethanolamide to product. This HPLC analysis was essentially unchanged from the earlier HPLC analysis performed 1.5 hours after completion of addition of the lauric acid diethanolamide. Titration of a pair of aliquots of the product obtained demonstrated and average of 20.59% epoxide (209.03 EEW). FTIR spectrophotometric analysis of neat thin films of both the polyol reactant and the polyglycidyl ether thereof on a KCl plate confirmed:

(1) maintenance of the integrity of the amide linkage in the polyglycidyl ether at 1645.2 cm⁻¹ for the polyglycidyl ether and 1621.0 cm⁻¹ for the polyol reactant,

(2) conversion of hydroxyl groups at 3381.3 cm⁻¹ in the polyol reactant with only a very minor hydroxyl absorbance present in the polyglycidyl ether at 3413.0 cm⁻¹,

(3) appearance of a strong aliphatic ether C—O stretch at 1110.9 cm⁻¹ in the polyglycidyl ether, and

(4) appearance of epoxide ether C—O stretch at 1253.7 cm⁻¹, 910.1 cm⁻¹ and 849.6 cm⁻¹ in the polyglycidyl ether.

Both the polyol reactant and the polyglycidyl ether product possessed a very minor absorbance (1743.5 cm⁻¹ and 1734.3 cm⁻¹, respectively) which may be indicative of a slight amount of ester functionality.

The progress of the epoxidation reaction was monitored by HPLC analysis, with the results shown in following table. “None” for the cumulative reaction time designates the lauric acid diethanolamide reactant used in the epoxidation reaction. “Final” designates the product recovered after completion of the work-up (rotary evaporation at 110° C.).

| Retention Time of | Cumulative Reaction Time After | | | | |
|---|---|---|---|---|---|
| Components | Completion of Lauric Acid | | | | |
| Present at | Diethanolamide Addition (area percent) | | | | |
| ≧2 area % (min) | None | 60 min | 3.8 hr | 20.0 hr | Final |
| 4.24 | 57.24 | 0 | 0 | 0 | 0 |
| 5.17 | 0 | 2.28 | 0 | 0 | 0 |
| 5.40 | 17.02 | 0 | 0 | 0 | 0 |
| 6.10 | 0 | 52.65 | 54.71 | 53.19 | 52.38 |
| 6.12 | 2.31 | 0 | 0 | 0 | 0 |
| 6.52 | 7.46 | 0 | 0 | 0 | 0 |
| 6.83 | 14.17 | 0 | 0 | 0 | 0 |
| 7.06 | 0 | 15.45 | 16.30 | 15.50 | 15.37 |
| 7.60 | 1.82 | 2.60 | 2.47 | 2.28 | 2.60 |
| 8.16 | 0 | 7.30 | 7.45 | 7.27 | 7.18 |
| 8.52 | 0 | 11.52 | 12.17 | 11.89 | 11.35 |
| 9.75 | 0 | 1.72 | 3.23 | 3.16 | 3.52 |
| 12.15 | 0 | 0 | 1.97 | 1.94 | 1.93 |

### Example 16

### Synthesis of a Polyglycidyl Ether of a Reductively Hydroformylated Soybean Oil Methyl Ester Amide Polyol (3.3 Functional)

### Development of Methodology for Clarification of the Polyglycidyl Ether

### A. Epoxidation

Reductively hydroformylated soybean oil methyl ester amide polyol (3.3 functional) containing 13.372% hydroxyl and 161 ppm of water was used directly in the epoxidation without predrying. A two liter, three neck, glass, round bottom reactor was charged under nitrogen with epichlorohydrin (925.3 grams, 10.0 moles), sodium hydroxide (pellets, anhydrous, reagent grade, ≧98%) (160.0 grams, 4.0 moles), and sodium sulfate (granular, anhydrous) (397.7 grams, 2.8 moles). The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). Reductively hydroformylated soybean oil methyl ester amide polyol (254.38 grams, 2.0 —OH equivalents) was added to a side arm vented addition funnel, then attached to the reactor. All glassware used for the epoxidation reaction was predried in the oven for ≧48 hours at 150° C. Stirring commenced to give a 25° C. slurry of sodium hydroxide and sodium sulfate in epichlorohydrin. After stirring for 15 minutes, heating of the reactor commenced using a thermostatically controlled heating mantle. Once the stirred slurry equilibrated at 40° C., an initial aliquot of dry reductively hydroformylated soybean oil methyl ester amide polyol (15 milliliters) was added to the reactor. The addition induced the formation of gelatinous appearing product which formed clumps out of the solid sodium hydroxide and sodium sulfate. The reaction temperature was maintained at 40° C. during the addition of the aliquots unless otherwise noted. The aliquots were added, as follows:

| Cumulative Time from | Amount of | |
|---|---|---|
| Addition of 1^{st} | Aliquot | |
| Aliquot (minutes) | (milliliters) | Observations |
| 25 | 20 | gelatinous material gone but re- |
| | | forms after addition |
| 45 | 20 | gelatinous material gone but re- |
| | | forms after addition |
| 85 | 25 | cloudy light tan colored slurry, |
| | | slight foaminess, gelatinous |
| | | material gone, only very slight |
| | | gelatinous material re-forms after |
| | | addition |
| 105 | 20 | thin slurry, slight foaminess, |
| | | gelatinous material gone, only |
| | | slight transient thickening of slurry |
| | | after addition |
| 125 | 25 | thin slurry, slight foaminess, no |
| | | thickening of slurry visually |
| | | observable after addition |
| 145 | 25 | thin slurry, slight foaminess |
| 165 | 25 | thin slurry, slight foaminess |
| 180 | 15 | thin, light tan colored slurry, slight |
| | | foaminess |

After a cumulative 18.8 hours of reaction, heating of the thin, light tan colored slurry ceased followed by addition of MIBK (800 milliliters) and cooling of the reactor exterior to 25° C. with a fan. At this time, HPLC analysis confirmed full conversion of the reductively hydroformylated soybean oil methyl ester amide polyol reactant used in the epoxidation reaction. The MIBK slurry was vacuum filtered over a one inch pad of diatomaceous earth (Celite™ 545) supported on a three liter coarse fritted glass funnel. The solids remaining on top of the diatomaceous earth were collected into a bottle containing fresh MIBK (800 milliliters), then placed on the mechanical shaker for one hour. The MIBK slurry was then vacuum filtered through the diatomaceous earth pad. Rotary evaporation of the filtrate using a maximum oil bath temperature of 70° C. provided 362.8 grams of cloudy, orange colored liquid. The product was dissolved in toluene (600 milliliters), then vacuum filtered over a one inch pad of Hyflo Super-Cel Celite™ diatomaceous earth supported on a 600 milliliter medium fritted glass funnel. Rotary evaporation of the filtrate using a maximum oil bath temperature of 77° C. provided 349.51 grams of opaque, caramel colored liquid. Titration of a pair of aliquots of the product obtained demonstrated an average of 22.18% epoxide (194.00 epoxide equivalent weight).

### B: Distillation to Remove Low Boiling Components

A portion (344.86 grams) of the product was added to a one liter, three neck, glass, round bottom reactor. The reactor was additionally equipped with a thermometer and a one piece integral vacuum jacketed Vigreaux distillation column and head was attached to the reactor. The distillation column nominally provided 5 to 10 theoretical plates depending on the mode of operation. The distillation head was equipped with an overhead thermometer, air cooled condenser, a receiver and a vacuum takeoff. A vacuum pump was employed along with a liquid nitrogen trap and an in-line digital thermal conductivity vacuum gauge. Stirring and heating of the reactor commenced using a thermostatically controlled heating mantle, along with gradually decreasing vacuum. Clear liquid was distilled from the product starting with pot temperature=128° C., overhead temperature=76° C., vacuum 9.3 psi and ending with pot temperature=190° C., overhead temperature=66° C., vacuum 7.5 psi over a 15 min period. A total of 307.08 grams of product was recovered as an opaque, caramel colored liquid.

### C. Solvent (Dichloromethane) Precipitation of Waxy Contaminant

The product was equally divided into two polypropylene bottles which were sealed and centrifuged at 2000 RPM for 1 hour. No precipitate was observed. Dichloromethane (50 milliliters) was added to both bottles of the product followed by hand shaking to mix and centrifuging at 3000 RPM for 1 hour. Approximately 2 to 3 grams of waxy solid precipitated and adhered to the bottom of the plastic bottles. The precipitate was removed and additional centrifuging was performed for 2.5 hour at 3000 RPM precipitating only a minor amount (<0.5 gram) of additional waxy solid. While some of the opacity was removed from the product, it was still hazy.

### D: Treatment with Activated Carbon

To each bottle of product in dichloromethane was added Calgon Activated Carbon Chips-CPG-LF 12×40 (10.0 grams per bottle). The bottles were placed on the mechanical shaker for the next 16 hours, removed, and then filtered to remove the carbon. After rotary evaporation to remove the dichloromethane, the product was light amber colored and still hazy. Titration of a pair of aliquots of the product obtained demonstrated an average of 20.71% epoxide (207.83 epoxide equivalent weight).

### E: Solvent (Acetone) Precipitation of Solid Contaminant

It was found that addition of acetone to the product induced precipitation of a minor amount of solid which was readily removed by centrifuging. The optimum amount of acetone for this solvent induced precipitation was 75 grams per 125 grams of product. After removal of the solid by centrifuging, rotary evaporation to remove the acetone using a maximum oil bath temperature of 80° C. gave a transparent, yellow colored product which was totally free of opacity or haziness. Titration of a pair of aliquots of the product obtained demonstrated an average of 20.77% epoxide (207.15 epoxide equivalent weight). Infrared spectrophotometric analysis of a neat thin film of the polyglycidyl ether on a KCl plate confirmed that the integrity of the amide linkage was maintained (1643.7 cm⁻¹, strong), hydroxyl groups were consumed (3438.4 cm⁻¹, weak), aliphatic ether stretch formed (1111.8 cm⁻¹, strong) and epoxide groups were formed (1253.3 cm⁻¹, 910.7 cm⁻¹, 849.1 cm⁻¹, medium).

### Example 17

### Clarification of a Polyglycidyl Ether of a Reductively Hydroformylated Soybean Oil Methyl Ester Amide Polyol (3.3 Functional) Using Silica Gel Chromatography

A portion (25.0 grams) of a polyglycidyl ether of a reductively hydroformylated soybean oil methyl ester amide polyol was dissolved in dichloromethane (35 grams). Titration of a pair of aliquots of the polyglycidyl ether used demonstrated an average of 21.07% epoxide (204.24 EEW) and was slightly opaque with a tan color. The solution was applied to a 5 inch tall by 1.5 inch diameter silica gel column which had been pre-equilibrated with dichloromethane. A solution of product was eluted from the column as a light yellow colored band using dichloromethane as the eluent. After complete elution of the light yellow colored band, a golden yellow colored band was left on the column starting at the origin and progressing 2 inches down the column. Rotary evaporation to remove dichloromethane from the solution of the light yellow colored band provided 13.62 grams of a transparent (free of any opacity), yellow colored liquid. Titration of a pair of aliquots of the product obtained demonstrated an average of 20.80% epoxide (206.91 EEW). FTIR spectrophotometric analysis of neat thin films of the polyglycidyl ether on a KCl plate before and after the treatment with silica gel revealed no changes in the product other than a very slight reduction in hydroxyl group absorbance in the sample treated with silica gel.

### Example 18

Treatment of a Polyglycidyl Ether of a Castor Oil Amide Polyol with Aqueous Sodium Dihydrogen Phosphate

A polyglycidyl ether of a castor oil amide polyol (950.4 grams) was dissolved in methylisobutylketone (950.4 grams). Titration of a pair of aliquots of the polyglycidyl ether used demonstrated an average of 20.45% epoxide (210.38 EEW). The solution was equally divided into a series of 3 separatory funnels and washed with a 1% wt. aqueous solution of sodium dihydrogen phosphate monohydrate (969 grams) which also was equally divided between the 3 separatory funnels. The recovered organic layers were added back into the respective separatory funnels and the aqueous layer discarded to waste. The solutions in the separatory funnels were washed twice with DI water (486 grams) which was equally divided between the 3 separatory funnels. Rotary evaporation using a maximum oil bath temperature of 85° C. to remove MIBK from the solution provided 880.2 grams of product. Titration of a pair of aliquots of the product obtained demonstrated an average of 20.05% epoxide (214.58 EEW). FTIR spectrophotometric analysis of neat thin films of the polyglycidyl ether on a KCl plate before and after the treatment with aqueous sodium dihydrogen phosphate revealed no changes in the product. Analysis of ionic chloride in aliquots of the product before and after the treatment with aqueous sodium dihydrogen phosphate revealed a reduction from 591.75 ppm to 94 ppm in the sample treated with aqueous sodium dihydrogen phosphate.

TABLE 1
Coatings Data

| | Wt. | | | | | | |
|---|---|---|---|---|---|---|---|
| | Ratio | | | | | | |
| | Epoxy | | | | | | |
| | Amide to | | | | | | |
| | D.E.R. ™ | | | | | Impact | |
| | 331 | Coating | | ⅛-inch | Cross | Strength | MEK |
| | Epoxy | Thickness | Pencil | Mandrel | Hatch | Direct/Reverse | Double |
| Example | Resin | (mils) | Hardness | Bend | Adhesion | (in. lbs.) | Rubs |
| 2 | 2/1 | 2.768 | 2B | No | 3B | 116/12 | >200 |
| | | | | Failure | (<15% | | |
| | | | | | Failure) | | |
| 4 | 2/1 | 2.573 | 2B | No | 3B | 156/32 | >200 |
| | | | | Failure | (<15% | | |
| | | | | | Failure) | | |
| 5 | 1/0 | 3.867 | 1H | No | 3B | 156/64 | >200 |
| | | | | Failure | (<15% | | |
| | | | | | Failure) | | |
| 8 | 2/1 | 2.253 | 2B | 8 mm | 4B (<5% | 68/<4 | >200 |
| | | | | Failure | Failure) | | |
| A | 0/1 | 4.796 | 2B | Total | 5B | 40/<2 | >200 |
| | | | | Failure | (No | | |
| | | | | | Failure) | | |

As illustrated by the results presented in Table 1, the epoxy amide derived from fatty acid esters, fatty acids and fatty acid triglycerides (Examples 2, 4, 5, and 8) may result in the resulting cured epoxy resin having increased flexibility and impact strength (greater damage tolerance) as compared to the comparative epoxy resin (Comparative Experiment A).

TABLE 2
Coatings Properties

| | | 60° Gloss After | |
|---|---|---|---|
| | | 1000 hours of | 85° Gloss After 1000 |
| | | Exposure to QUVA | hours of Exposure to |
| | | Chamber | QUVA Chamber |
| | | Conditions | Conditions |
| Example | Epoxy Used | (% Reflectance) | (% Reflectance) |
| 2 | Blend of 2 to 1 by weight of | 62 | 66 |
| | Polyglycidyl Ether of Amide | | |
| | Polyol from Castor Oil & the | | |
| | Diglycidyl Ether of Bisphenol A | | |
| 4 | Blend of 2 to 1 by weight of | 85 | 92 |
| | Polyglycidyl Ether of a | | |
| | Reductively Hydroformylated | | |
| | Soybean Oil Methyl Ester Amide | | |
| | Polyol & the Diglycidyl Ether of | | |
| | Bisphenol A | | |
| 5 | Polyglycidyl Ether of a | 78 | 91 |
| | Reductively Hydroformylated | | |
| | Soybean Oil Methyl Ester Amide | | |
| | Polyol | | |
| 8 | Blend of 2 to 1 by weight of | 43 | 52 |
| | Polyglycidyl Ether of Methyl 11- | | |
| | Hydroxyundecanoate Amide | | |
| | Polyol & the Diglycidyl Ether of | | |
| | Bisphenol A | | |
| A | Diglycidyl Ether of Bisphenol A | <3 | <10 |

As illustrated by the results presented in Table 2, the epoxy amide derived from fatty acid esters and fatty acid triglycerides (Examples 2, 4, 5 and 8) may result in the resulting cured epoxy resin having increased UV stability as measured by gloss retention as compared to the comparative epoxy resin (Comparative Experiment A).

As described above, anhydrous epihalohydrin epoxidation of multifunctional polyols and acids derived from fatty acid esters and fatty acid triglycerides may result in new glycidyl ethers and esters with cure rates comparable to conventional epoxy resins. Having this new level of reactivity may allow application in coatings where the seed oil structure may provide for improved processing and performance for conventional epoxy resins.

Advantageously, embodiments disclosed herein may provide for one or more of: lower viscosities, which may eliminate the need for solvents in coatings formulations (no VOC's); excellent UV stability in combination with good adhesion and corrosion resistance, which may eliminate the need for multiple coats in many industrial, marine, and automotive applications; and improved flexibility and damage tolerance for epoxy resin coatings. Additionally, compositions described herein may have higher crosslink density (improved thermal stability), improved reactivity due to the structural design of the backbone, higher degrees of epoxidation (fewer side-products), and glycidyl ether functionality.

While the present invention includes a limited number of embodiments, those skilled in the art, having benefit of this disclosure, will appreciate that other embodiments may be devised which do not depart from the scope of the present invention.

Accordingly, the scope of the present invention should be limited only by the attached claims.

### Example 19

### Silica Gel Chromatographic Treatment of a Polyglycidyl Ether of a Reductively Hydroformylated Soybean Oil Methyl Ester Amide Polyol (3.3 Functional) to Increase Shelf Stability

### A. Untreated Polyglycidyl Ether of a Reductively Hydroformylated Soybean Oil Methyl Ester Amide Polyol

Polyglycidyl ether of a reductively hydroformylated soybean oil methyl ester amide polyol from Example 13 was held in a sealed glass bottle at room temperature and the viscosity determined as a function of time. The viscosity measurements (25° C.) were performed in accordance with ASTM Method D 4287 using and I.C.I. Cone and Plate Rheometer.

### B. Silica Gel Treated Polyglycidyl Ether of a Reductively Hydroformylated Soybean Oil Methyl Ester Amide Polyol

A portion (70.0 grams) of a polyglycidyl ether of a reductively hydroformylated soybean oil methyl ester amide polyol was dissolved in dichloromethane (100 milliliters). Titration of a pair of aliquots of the polyglycidyl ether used demonstrated an average of 20.74% epoxide (207.45 EEW), a hydrolyzable chloride value of 6107 ppm and an ionic chloride value of 681.6 ppm. The solution was applied to a bed prepared by layering one inch of diatomaceous earth (Celite™ 545), followed by one half inch silica gel (Merck grade 9385, 230-400 mesh, 60 angstroms), followed by one inch of diatomaceous earth (Celite™ 545) in a 600 milliliter medium fritted glass funnel. The product was eluted from the bed using dichloromethane (0.5 liter) as the eluent. Rotary evaporation to remove dichloromethane provided 60.68 grams of a transparent, light yellow colored liquid. Titration of a pair of aliquots of the product obtained demonstrated an average of 20.54% epoxide (209.49 EEW). FTIR spectrophotometric analysis of neat thin films of the polyglycidyl ether on a KCl plate before and after the treatment with silica gel revealed no changes in the product other than a very slight reduction in hydroxyl group absorbance in the sample treated with silica gel.

A portion of the silica gel chromatographically purified polyglycidyl ether was held in a sealed glass bottle at room temperature and the viscosity determined as a function of time. The viscosity measurements were performed in accordance with ASTM Method D 4287 using and I.C.I. Cone and Plate Rheometer giving the following results:

| Silica Gel Treated | | | |
|---|---|---|---|
| Polyglycidyl Ether | | Untreated Polyglycidyl | |
| | 25° C. | Ether | |
| Time (days) | Viscosity (cps) | Time (days) | 25° C. Viscosity (cps) |
| 0 | 3525 | 0 | 3300 |
| 8 | 3575 | 6 | 3325 |
| 39 | 3650 | 13 | 3325 |
| 56 | 3750 | 29 | 3400 |
| 64 | 3750 | 37 | 3500 |
| 70 | 3825 | 47 | 3550 |
| 78 | 3750 | 61 | 3800 |
| 89 | 3750 | 75 | ~5000 |
| 104 | 3800 | | |
| 130 | 3725 | | |
| 144 | 3800 | | |
| 158 | 3850 | | |
| 203 | 4100 | | |

1. An epoxy resin comprising at least one epoxy amide derived from at least one seed oil based alkanolamide.

2. The epoxy resin of claim 1 wherein the seed oil based alkanolamide is derived from the reaction of (i) at least one of a fatty acid ester, a fatty acid and a fatty acid triglyceride; and (ii) at least one alkanolamine.

3. The epoxy resin of claim 1 wherein the epoxy amide comprises (i) at least one of a glycidyl ether amide and a glycidyl ester amide; (ii) wherein the epoxy amide comprises at least one of a polyglycidyl ether amide and a polyglycidyl ester amide; (iii) wherein the epoxy amide is represented by the following Formula I: 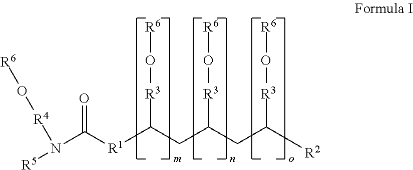
wherein R¹ and R⁴ may each independently be a hydrocarbylene moiety; R² is hydrogen or a monovalent hydrocarbyl moiety; R³ is nil or a hydrocarbylene moiety; R⁵ is hydrogen or a monovalent hydrocarbyl moiety, or a moiety represented by Formula II:
—R⁴—O—R⁶ Formula II
wherein R⁴ is as defined above and R⁶ is a moiety of either Formula III or Formula IV: 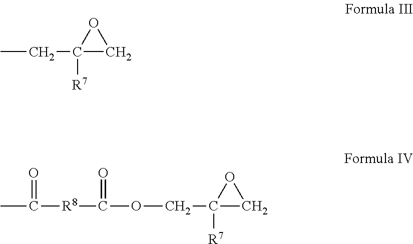
wherein R⁷ is hydrogen or an aliphatic hydrocarbon group having from 1 to about 4 carbon atoms; R⁸ is a hydrocarbylene moiety; and m, n, and o are independently 0 or 1; or (iv) wherein the epoxy amide comprises at least one of a polyglycidyl ether amide, a polyglycidyl ester amide and any oligomer thereof derived from at least one of a fatty acid ester, a fatty acid, a fatty acid triglyceride and any oligomer thereof.

4. The epoxy resin according to claim 1, comprising
(a) a polyglycidyl ether amide derived from at least one of a fatty acid ester, a fatty acid, and a fatty acid triglyceride; and
(b) a monoglycidyl ether amide derived from at least one of a fatty acid ester, a fatty acid and a fatty acid triglyceride.

5. A process of preparing an epoxy amide comprising reacting (a) at least one seed oil based alkanolamide, (b) an epihalohydrin, (c) a basic acting substance; and (d) optionally, a solvent.

6. The process according to claim 5, wherein the process is a slurry epoxidation process; and wherein the slurry epoxidation process comprises reacting (a) a polyglycidyl ether derived from at least one of a fatty acid ester, a fatty acid and a fatty acid triglyceride, (b) an epihalohydrin, (c) a basic acting substance in an solid form or in an aqueous solution, optionally, (d) a solvent other than water, optionally, (e) a catalyst, and optionally (f) a dehydrating agent.

7. The process according to claim 5, wherein the process is an anhydrous epoxidation process; and wherein the anhydrous epoxidation process comprises reacting (a) a polyglycidyl ether derived from at least one of a fatty acid ester, a fatty acid and a fatty acid triglyceride, (b) an epihalohydrin, and (c) a basic acting substance in an aqueous solution, optionally (d) a solvent, and optionally (e) a catalyst.

8. The process according to claim 5, wherein the process is a Lewis acid catalyzed coupling and epoxidation process; and wherein the Lewis acid catalyzed coupling and epoxidation process comprises reacting, (A) in a coupling reaction, (a) a polyglycidyl ether derived from at least one of a fatty acid ester, a fatty acid and a fatty acid triglyceride, (b) an epihalohydrin in the presence of (c) a Lewis acid catalyst, followed by (B) a dehydrohalogenation reaction of a resultant halohydrin intermediate in Step (A) using (d) a basic acting substance in an aqueous solution, optionally (d) a solvent and, optionally (e) a catalyst other than the Lewis acid catalyst.

9. An article comprising the epoxy amide according to claim 1; and wherein the article is at least one of a coating, an electrical or structural laminate, an electrical or structural composite, a filament winding, a molding, a casting, an adhesive, or an encapsulation.

10. An epoxy resin composition comprising a mixture of (a) the epoxy amide of claim 1; and (b) a mono- or polyvalent glycidyl sulfide, glycidyl amine, N-(glycidyl) amide, a glycidyl ether not represented by Formula I, or a glycidyl ester not represented by Formula I.

11. An oligomer formed by advancement of the glycidyl amide of claim 1 with a polyvalent nucleophile; and wherein the polyvalent nucleophile is a phenol, a carboxylic acid, an amine, a thiol or an alchohol.

12. An epoxy resin composition comprising a mixture of (a) the oligomer of claim 11 in combination with (b) the epoxy amide of claim 1 or the epoxy resin composition of claim 10.

13. An epoxy resin composition comprising a mixture of (a) an epoxy amide comprising a glycidyl ether amide derived from at least one seed oil based alkanolamide, and (b) one or more epoxy resins other than the epoxy resin (a).

14. A curable epoxy resin composition comprising (a) the epoxy resin composition of claim 13, and (b) at least one curing agent and/or at least one curing catalyst; and wherein the curing agent comprises a material having at least one reactive hydrogen atom per molecule, and the epoxy resin composition comprises at least one epoxide group, and the reactive hydrogen atom in the curing agent is reactive with the epoxide group in the epoxy resin reactive diluent composition.

15. A process comprising curing the curable epoxy resin composition according to claim 14.

16. An article comprising the cured epoxy resin prepared by the process according to claim 15; and wherein the article is at least one of a coating, an electrical or structural laminate, an electrical or structural composite, a filament winding, a molding, a casting, and an encapsulation.
